(19) United States
(12) Patent Application Publication
(10) Pub. No.: US 2009/0306277 A1
(43) Pub. Date: Dec. 10, 2009

(54) RESIN SYSTEMS INCLUDING REACTIVE SURFACE-MODIFIED NANOPARTICLES

(76) Inventors: Emily S. Goenner, Shoreview, MN (US); Howard S. Creel, Oakdale, MN (US); Andrew M. Hine, Saint Paul, MN (US); Brant U. Kolb, Afton, MN (US); Gene B. Portelli, Woodbury, MN (US); Wendy L. Thompson, Roseville, MN (US)

Correspondence Address: 3M INNOVATIVE PROPERTIES COMPANY, PO BOX 33427, ST. PAUL, MN, 55133-3427, US

(21) Appl. No.: 12/438,966

(22) PCT Filed: Aug. 29, 2007
(86) PCT No.: PCT/US07/77130

§ 371 Date: Jul. 30, 2009

Related U.S. Application Data
(60) Provisional application No. 60/823,789, filed on Aug. 29, 2006.

(51) Int. Cl. C08L 63/00; C08F 8/00

(52) U.S. Cl. 524/556; 525/55; 525/119; 525/244

(57) ABSTRACT

Resin systems comprising a crosslinkable resin, a reactive diluent, and a plurality of reactive, surface-modified nanoparticles; and gel coats including such resin systems are described. Articles having such compositions attached to a surface of a substrate, e.g., a fibrous reinforced substrate, are also described.

### FIELD

The present disclosure relates to resin systems comprising reactive surface-modified nanoparticles, including gel coats and articles incorporating such resin systems.

### SUMMARY

In one aspect, the present disclosure provides a gel coat composition having a resin system, where the resin system includes a crosslinkable resin; a reactive diluent; and a plurality of reactive, surface-modified nanoparticles. The surface-modified nanoparticles include a core having a surface and a first surface treatment agent. The first surface treatment agent has a first functional group attached to the surface of the core and a second functional group capable of reacting with the crosslinkable resin and/or the reactive diluent.

In some embodiments, the first functional group covalently attaches the first surface treatment agent to the core. In some embodiments, the first surface treatment agent comprises at least one of an alcohol, an amine, a carboxylic acid a sulfonic acid, a phosphonic acid, a silane and a titanate.

In some embodiments, the surface-modified nanoparticles have an average particle size of from 5 nanometers to 250 nanometers.

In some embodiments, the composition is substantially free of reactive rubber domains.

In some embodiments, the resin system has about 5 to about 60 percent by weight of the reactive, surface-modified nanoparticles. In some embodiments, the resin system is less than or equal to 40 percent by weight reactive diluent. In some embodiments, the reactive diluent is an ethylenically unsaturated monomeric compound. In some embodiments, the reactive diluent may be styrene, alpha-methylstyrene, vinyl toluene, divinylbenzene, methyl methacrylate, diallyl phthalate, triallyl cyanurate or a mixture thereof.

In some embodiments, the crosslinkable resin may be an unsaturated polyester resin. In other embodiments, the crosslinkable resin may be the reaction product of one or more epoxy resins with one or more ethylenically-unsaturated monocarboxylic acids.

In some embodiments, the surface of the core of the surface-modified nanoparticles may be an inorganic oxide, including but not limited to silica, titania, alumina, zirconia, vanadia, antimony oxide, tin oxide, zinc oxide, ceria, and mixtures thereof.

In some embodiments, the reactive, surface modified nanoparticles also include a second surface treatment agent, where the second surface treatment agent is attached to the surface of the core.

In some embodiments, the composition includes an additive. Exemplary additives include a catalyst, a crosslinking agent, an inhibitor, a dye, a pigment, a flame retardant, an impact modifier, an initiator, an activator a promoter, an air release agent, a wetting agent, a leveling agent, a surfactant, a suppressant, a flow control agent, or a mixture thereof. In some embodiments, the composition includes a thixotropic agent. In some embodiments, the composition may have a thixotropic index greater than or equal to 4.

In another aspect, the present disclosure provides an article having a substrate and a cured gel coat layer attached to a surface of the substrate, where the cured gel coat layer is a reaction product of a crosslinkable resin; a reactive diluent; and a plurality of reactive, surface-modified nanoparticles. The surface-modified nanoparticles include a core having a surface and a first surface treatment agent. The first surface treatment agent includes a first functional group attached to the surface of the core and a second functional group reacted with at least one of the crosslinkable resin and the reactive diluent. In some embodiments, the article may be a vehicle and/or a fixture. In some embodiments, the substrate may be a fibrous reinforced composite.

In yet another aspect, the present disclosure provides a resin system having a crosslinkable resin; a reactive diluent; and a plurality of reactive, surface-modified nanoparticles. The surface-modified nanoparticles include a core with a surface and a first surface treatment agent. The first surface treatment agent includes a first functional group attached to the surface of the core and a second functional group capable of reacting with the crosslinkable resin and/or the reactive diluent; and a second surface treatment agent attached to the surface of the core.

In another aspect, the present disclosure provides a composition having a crosslinkable resin; a reactive diluent; and a plurality of reactive, surface-modified nanoparticles. The surface-modified nanoparticles include a core with a surface and a first surface treatment agent. The first surface treatment agent includes a first functional group attached to the surface of the core. The weight percent of the first surface treatment agent, based on a total weight of the composition, is selected such that where the composition has a thixotropic index greater than or equal to 4.

The above summary of the present disclosure is not intended to describe each embodiment of the present invention. The details of one or more embodiments of the invention are also set forth in the description below. Other features, objects, and advantages of the invention will be apparent from the description and from the claims.

### DETAILED DESCRIPTION

As used herein, the term “silica” refers to the compound silicon dioxide. See Kirk-Othmer Encyclopedia of Chemical Technology, 4th Ed., Vol. 21, pp. 977-1032 (1977).

As used herein, the terms “primary silica particles” or “ultimate silica particles” are used interchangeably and refer to the smallest unit particle. Primary or ultimate silica particles are typically fully densified (i.e., fully condensed).

As used herein, the term “amorphous silica” refers to silica that does not have a crystalline structure as defined by x-ray diffraction measurements.

As used herein, the term “silica sol” refers to a stable dispersion of discrete, amorphous silica particles in a liquid, typically water.

As used herein, the term “substantially spherical” refers to the general shape of the silica particles. Substantially spherical silica particles have an average aspect ratio of at most about 4:1, in some embodiments, at most about 3:1, at most about 2:1, or even at most about 1.5:1. In some embodiments, the average aspect ratio is about 1:1.

As used herein, “agglomerated” is descriptive of a weak association of primary particles usually held together by charge or polarity. Agglomerated particles can typically be broken down into smaller entities by, for example, shearing forces encountered during dispersion of the agglomerated particles in a liquid.

In general, “aggregated” and “aggregates” are descriptive of a strong association of primary particles often bound together by, for example, residual chemical treatment, covalent chemical bonds, or ionic chemical bonds. Further breakdown of the aggregates into smaller entities is very difficult to achieve. Typically, aggregated particles are not broken down into smaller entities by, for example, shearing forces encountered during dispersion of the aggregated particles in a liquid.

As used herein, “particle size” refers to the longest dimension of a particle, e.g. the diameter of a sphere or the major axis of an ellipsoid.

Gel coats are commonly present on a surface of a substrate, for example a fibrous reinforced composite, to provide a durable and/or aesthetically desirable surface layer. Exemplary applications include vehicles such as watercraft, aircraft, and recreational vehicles and fixtures such as sinks, tubs, spas, and shower stalls. For example, a mold having a release surface corresponding to the desired final shape and surface finish of the article is prepared. A gel coat is applied to the release surface by, e.g., spraying. Additional layers, such as fiber reinforced resins, are then applied to the gel coat. Following curing, the article is removed from the mold and the gel coat provides the final finished surface of the article.

Generally, gel coats of the present disclosure include a resin system and any number of a variety of optional additives, including but not limited to a thixotropic agent for providing a thixotropy index sufficient to allow the gel coat be sprayed onto non-horizontal surfaces with minimal sagging. Other additives include, but are not limited to, particulates for opacity and color, dyes for color, and/or waxes to improve cure by blocking oxygen at the gel coat-air interface.

As used herein “thixotropy index” is the ratio of the room temperature viscosity measured at 5 rpm divided by the room temperature viscosity measured at 50 rpm using a Brookfield viscometer, Model DV-II+ (Brookfield Eng Labs, Inc. Stoughton, Mass. 02072) with a #4 spindle.

As used herein, “resin system” refers to the major reactive elements that co-react to form the final cured gel coat. The resin systems of the present disclosure comprise one or more crosslinkable resins, one or more reactive diluents, and a plurality of reactive, surface-modified nanoparticles. In some embodiments, the resin system is substantially free of reactive rubber domains.

As used herein, “reactive rubber domains” refer to rubber domains, i.e. domains having a glass transition temperature of −20° C. or less, that include groups that can react with the crosslinkable resin or the reactive diluent. A composition having less than 1 percent by weight of reactive rubber domains relative to the total weight of a resin system is substantially free of reactive rubber domains.

Generally, any known crosslinkable resin may be used. In some embodiments, the crosslinkable resin is an ethylenically-unsaturated crosslinkable resin (e.g., unsaturated polyesters, “vinyl esters”, and acrylates (e.g., urethane acrylates)). As used herein, the term “vinyl ester” refers to the reaction product of epoxy resins with ethylenically-unsaturated monocarboxylic acids. Although such reaction products are acrylic or methacrylic esters, the term “vinyl ester” is used consistently in the gel coat industry. (See, e.g., Handbook of Thermoset Plastics (Second Edition), William Andrew Publishing, page 122 (1998).)

The crosslinkable resins may be present in the resin system as monomers and/or prepolymers (e.g., oligomers). Generally, the molecular weight of the crosslinkable resin is sufficiently low such that the crosslinkable resin is soluble in the reactive diluent.

In some embodiments, an unsaturated polyester resin may be used. In some embodiments, the unsaturated polyester resin is the condensation product of one or more carboxylic acids or derivatives thereof (e.g., anhydrides and esters) with one or more alcohols (e.g., polyhydric alcohols).

In some embodiments, one or more of the carboxylic acids may be an unsaturated carboxylic acid. In some embodiments, one or more of the carboxylic acids may be a saturated carboxylic acid. In some embodiments, one or more of the carboxylic acids may be aromatic carboxylic acids. In some embodiments, combinations of saturated, unsaturated and/or aromatic carboxylic acids may be used.

Exemplary unsaturated carboxylic acids include acrylic acid, chloromaleic acid, citraconic acid, fumaric acid, itaconic acid, maleic acid, mesaconic acid, methacrylic acid, and methyleneglutaric acid.

Exemplary saturated or aromatic carboxylic acids include adipic acid, benzoic acid, chlorendic acid, dihydrophthalic acid, dimethyl-2,6-naphthenic dicarboxylic acid, d-methylglutaric acid, dodecanedicarboxylic acid, ethylhexanoic acid, glutaric acid, hexahydrophthalic acid, isophthalic acid, nadic anhydride o-phthalic acid, phthalic acid, pimelic acid, propionic acid, sebacic acid, succinic acid, terephthalic acid, tetrachlorophthalic acid, tetrahydrophthalic acid, trimellitic acid, 1,2,4,5-benzenetetracarboxylic acid, 1,2,4-benzenetricarboxylic acid, 1,2-cyclohexane dicarboxylic acid, 1,3 cyclohexane dicarboxylic acid, 1,4-cyclohexane dicarboxylic acid, dicyclopentadiene acid maleate, Diels-Alder adducts made from maleic anhydride and cyclopentadiene, and orthophthalic acid.

In some embodiments, the alcohol is a polyhydric alcohol, e.g., a dihydric alcohol. Exemplary polyhydric alcohols include alkanediols, butane-1,4-diol, cyclohexane-1,2-diol, cyclohexane dimethanol, diethyleneglycol, dipentaerythritol, di-trimethylolpropane, ethylene glycol, hexane-1,6-diol, neopentyl glycol, oxa-alkanediols, polyethyleneglycol, propane-3-diol, propylene glycol, triethyleneglycol, trimethylolpropane, tripentaerythirol, 1,2-propyleneglycol, 1,3-butyleneglycol, 2-methyl-1,3-propanediol, 2,2,4-trimethyl-1-3,-pentanediol, 2,2-bis(p-hydroxycyclohexyl)-propane, 2,2-dimethylheptanediol, 2,2-dimethyloctanediol, 2,2-dimethylpropane-1,3-diol, 2,3-norborene diol, 2-butyl-2-ethyl-1,3-propanediol, 5-norborene-2,2-dimethylol, and 2,3 dimethyl 1,4 butanediol.

Monofunctional alcohols may also be used. Exemplary monofunctional alcohols include benzyl alcohol, cyclohexanol, 2-ethylhexyl alcohol, 2-cyclohexyl alcohol, 2,2-dimethyl-1-propanol, and lauryl alcohol.

In some embodiments, the carboxylic acid is selected from the group consisting of isophthalic acid, orthophthalic acid, maleic acid, fumaric acid, esters and anhydrides thereof, and combinations thereof. In some embodiments, the alcohol is selected from the group consisting of neopentyl glycol, propylene glycol, ethylene glycol, diethylene glycol, 2-methyl-1,3-propane diol, and combinations thereof.

In some embodiments, vinyl ester resins are used. As used herein, the term “vinyl ester” refers to the reaction product of epoxy resins with ethylenically-unsaturated monocarboxylic acids. Exemplary epoxy resins include bisphenol A digycidal ether (e.g., EPON 828, available from Miller-Stephenson Products, Danbury, Conn.). Exemplary monocarboxylic acids include acrylic acid and methacrylic acid.

Generally, the crosslinkable resin is both soluble in the reactive diluent of the resin system and reacts with the reactive diluent to form a copolymerized network. Generally, any known reactive diluent may be used. Exemplary reactive diluents include styrene, alpha-methylstyrene, vinyl toluene, divinylbenzene, methyl methacrylate, diallyl phthalate, ethylene glycol dimethacrylate, hydroxyethyl methacrylate, hydroxyethyl acrylate and triallyl cyanurate.

In addition to the crosslinkable resin and the reactive diluent, the resin systems of the present disclosure also include a plurality of reactive, surface-modified nanoparticles. Unlike the fillers that are added to the resin systems of conventional gel coats, the reactive, surface-modified nanoparticles of the present disclosure react with at least one of the crosslinkable resin or the reactive diluent to form part of the final crosslinked structure comprising the crosslinkable resin, the reactive diluent, and the surface-modified nanoparticles. Therefore, rather than being fillers, the reactive, surface modified nanoparticles of the present disclosure are part of the resin system itself. Also, the reactive, surface-modified nanoparticles are tied into a network with the organic resins (i.e., the crosslinkable resin and the reactive diluent) rather than being present as, e.g., an independent network.

Generally, a reactive, surface modified nanoparticle comprises surface treatment agents attached to the surface of a core, where the surface treatment agent includes a first group attached to the surface of the core, and a second group capable of reacting with other components of the resin system. In some embodiments, the surface comprises a metal oxide. Any known metal oxide may be used. Exemplary metal oxides include silica, titania, alumina, zirconia, vanadia, chromia, antimony oxide, tin oxide, zinc oxide, ceria, and mixtures thereof. In some embodiments, the core comprises an oxide of one metal deposited on an oxide of another metal. In some embodiments, the core comprises a metal oxide deposited on a non-metal oxide.

In some embodiments, the reactive surface-modified nanoparticles have a primary particle size of between about 5 nanometers to about 500 nanometers, and in some embodiments from about 5 nanometers to about 250 nanometers, and even in some embodiments from about 50 nanometers to about 200 nanometers. In some embodiments, the cores have an average diameter of at least about 5 nanometers, in some embodiments, at least about 10 nanometers, at least about 25 nanometers, at least about 50 nanometers, and in some embodiments, at least about 75 nanometers. In some embodiments the cores have an average diameter of no greater than about 500 nanometers, no greater than about 250 nanometers, and in some embodiments no greater than about 150 nanometers. Particle size measurements can be based on, e.g., transmission electron microscopy (TEM).

In some embodiments, reactive, surface-modified zirconia nanoparticles may have a particle size from about 5 to 50 about nm, in some embodiments, about 5 to 15 nm, and in some embodiments, about 10 nm. In some embodiments, zirconia nanoparticles can be present in an amount of from about 10 to about 70 weight % (wt. %), and in some embodiments from about 30 to about 60 wt. % based on the total weight of the resin system. Exemplary zirconias are available from Nalco Chemical Co. under the trade designation “Nalco OOSSOO8” and from Buhler AG Uzwil, Switzerland under the trade designation “Buhler zirconia Z-WO sol”. Zirconia nanoparticle can also be prepared using known techniques such as described in U.S. patent application Ser. No. 11/027,426 filed Dec. 30, 2004 and U.S. Pat. No. 6,376,590.

Titania, antimony oxides, alumina, tin oxides, and/or mixed metal oxide nanoparticles can have a primary particle size or agglomerated particle size from about 5 to about 50 nm, in some embodiments, about 5 to about 15 nm, and in some embodiments, about 10 nm. Titania, antimony oxides, alumina, tin oxides, and/or mixed metal oxide nanoparticles can be present in an amount from about 10 to about 70 wt. %, and in some embodiments, about 30 to about 60 wt. % based on the total weight of the resin system. Exemplary mixed metal oxides for use in materials of the invention are commercially available from Catalysts & Chemical Industries Corp., Kawasaki, Japan, under the trade designation “Optolake 3.”

In some embodiments, silica nanoparticles can have a particle size of ranging from about 5 to about 150 nm. Commercially available silicas include those available from Nalco Chemical Company, Naperville, Ill. (for example, NALCO 1040, 1042, 1050, 1060, 2327 and 2329) and Nissan Chemical America Company, Houston, Tex.

In some embodiments, the core is substantially spherical. In some embodiments, the cores are relatively uniform in primary particle size. In some embodiments, the cores have a narrow particle size distribution. In some embodiments, the core is substantially fully condensed. In some embodiments, the core is amorphous. In some embodiments, the core is isotropic. In some embodiments, the core is at least partially crystalline. In some embodiments, the core is substantially crystalline. In some embodiments, the particles are substantially non-agglomerated. In some embodiments, the particles are substantially non-aggregated in contrast to, for example, fumed or pyrogenic silica.

Generally, a surface treatment agent is an organic species having a first functional group capable of attaching (e.g., chemically (e.g., covalently or ionically) attaching, or physically (e.g., strong physisorptively) attaching) to the surface of the core of a nanoparticle, wherein the attached surface treatment agent alters one or more properties of the nanoparticle. In some embodiments, surface treatment agents have no more than three functional groups for attaching to the core. In some embodiments, the surface treatment agents have a low molecular weight, e.g. a weight average molecular weight less than 1000. The surface-modified nanoparticles of the present disclosure are reactive; therefore, at least one of the surface treatment agents used to surface modify the nanoparticles of the present disclosure includes a second functional group capable of reacting with one or more of the crosslinkable resin(s) and/or one or more of the reactive diluent(s) of the resin system.

In some embodiments, the surface treatment agent further includes one or more additional functional groups providing one or more additional desired properties. For example, in some embodiments, an additional functional group may be selected to provide a desired degree of compatibility between the reactive, surface modified nanoparticles and one or more of the additional constituents of the resin system, e.g., one or more of the crosslinkable resins and/or reactive diluents. In some embodiments, an additional functional group may be selected to modify the rheology of the resin system, e.g., to increase or decrease the viscosity, or to provide non-Newtonian rheological behavior, e.g., thixotropy (shear-thinning).

Nanocomposites having a wide range of rheological behavior can be obtained by different combinations of particle surface treatment agents, crosslinkable resins and reactive diluents. Surface treatment agents that make the particles more compatible with the crosslinkable resins and/or reactive diluents tend to provide fluid, relatively low viscosity, substantially Newtonian compositions. Surface treatment agents that make the particles only marginally compatible with the crosslinkable resins and/or reactive diluents tend to provide compositions that exhibit one or more of thixotropy, shear thinning, and/or reversible gel formation, preferably in combination with low elasticity. Surface treatment agents that are more incompatible with the crosslinkable resins and/or reactive diluents generally provide formulations that tend to settle, phase separate, agglomerate or the like. Thus, it can be appreciated that the selection of the surface treatment agents offers tremendous control and flexibility over rheological characteristics.

For gel coats that are applied by spraying, particularly preferred compositions are in the form of thickened compositions that exhibit desirable shear thinning behavior, having low elasticity and substantially no yield stress when in the uncured state. Thickening properties with shear thinning behavior preferably result by selecting a surface treatment agent that renders the particles only marginally compatible with the crosslinkable resins and/or reactive diluents so as to promote the desired thickening, thixotropic, and shear-thinning characteristics. Marginally compatible surface treatment agents tend to provide systems in which rheological behavior depends upon the amount of energy imparted to the system. For example, preferred composition embodiments may exist as a high viscosity composition at room temperature and low (or no) shear. Upon imparting higher shear, heating to a higher temperature (e.g., about 60.degree. C.), and/or imparting sonic or other suitable energy to the composition, the composition is transformed into a low viscosity fluid. Upon cooling and/or removing the sonic and/or shear energy, the thickened composition reforms.

In one embodiment, a combination comprising relatively polar and nonpolar surface treatment agents is used to achieve surface modification of particles. The use of such a combination of surface treatment agents allows the compatibility between the surface modified particles and the crosslinkable resins and/or reactive diluents to be easily adjusted by varying the relative amounts of such surface treatment agents. Of course, as another option in certain cases, a single surface treatment agent may also be used. Alternatively, or in addition to this approach, the crosslinkable resins and/or reactive diluents also may comprise relatively polar and nonpolar constituents. This approach also allows the degree of compatibility with the particles to be adjusted by varying the relative amounts of these resin constituents.

While not wishing to be bound by theory, it is believed that the compatibility between the crosslinkable resins and/or reactive diluents and the particle surface treatment agents tends to favor particle-reactive diluent and/or particle-crosslinkable resin interactions over particle-particle interactions. When particle-reactive diluent and/or particle-crosslinkable resin interactions are favored, the compositions tend to exist as a low viscosity Newtonian fluid. In contrast, when particle-particle interactions are more favored, the compositions tend to thicken more significantly as the volume percent of particles is increased.

In some embodiments, two or more different surface treatment agents may be used. In some embodiments, multiple surface treatment agents may be used to achieve the desired degree of a single functional parameter. For example, multiple surface treatment agents may be attached to the nanoparticle cores to achieve the desired degree of compatibility with the remaining components of the resin system. In some embodiments, multiple surface treatment agents may be used to achieve the desired levels of two or more functional parameters. For example, one or more functional groups may used to achieve the desired rheology within the uncured resin system, while one or more functional groups may be used to achieve the desired properties (e.g., physical properties) of the cured resin system.

Surface-treating the nano-sized particles can provide a stable dispersion in the resin system. Preferably, the surface-treatment stabilizes the nanoparticles so that the particles will be well dispersed in the other components of the resin system and results in a substantially homogeneous composition. Furthermore, the nanoparticles can be modified over at least a portion of its surface with a surface treatment agent so that the stabilized particle can copolymerize or react with the polymerizable resin during curing.

Examples of surface treatment agents include alcohols, amines, carboxylic acids, sulfonic acids, phosphonic acids, silanes and titanates. The selection of a particular treatment agent is determined, in part, by the chemical nature of the metal oxide surface. In some embodiments, silanes may be used for silica and other for siliceous fillers. In some embodiments, silanes and carboxylic acids may be used for metal oxides such as zirconia.

The surface modification can be done either prior to mixing with one or more of the other components of the resin system or after mixing. In some embodiments, it may be useful to react silanes with the particle or nanoparticle surface before incorporation into the other components of the resin system.

The required amount of surface treatment agent is dependant upon several factors such particle size, particle type, particle surface area, surface treatment agent molecular weight, and surface treatment agent type. In some embodiments, approximately a monolayer of surface treatment agent is attached to the surface of the particle. The attachment procedure or reaction conditions required also depend on the surface treatment agent used. In some embodiments, e.g., with silanes, it may be useful to surface treat at elevated temperatures under acidic or basic conditions for from 1-24 hours. Surface treatment agents such as carboxylic acids may not require elevated temperatures or extended time.

Representative types of surface treatment agents suitable for the compositions of the present disclosure include compounds such as, for example, [2-(3-cyclohexenyl)ethyl]trimethoxysilane, trimethoxy(7-octen-1-yl)silane, isooctyl trimethoxy-silane, N-(3-triethoxysilylpropyl)methoxyethoxyethoxyethyl carbamate, N-(3-triethoxysilylpropyl)methoxyethoxyethoxyethyl carbamate, 3-(methacryloyloxy)propyltrimethoxysilane, allyl trimethoxysilane, 3-acryloxypropyltrimethoxysilane, 3-(methacryloyloxy)propyltriethoxysilane, 3-(methacryloyloxy)propylmethyldimethoxysilane, 3-acryloyloxypropyl)methyldimethoxysilane, 3-(methacryloyloxy)propyldimethylethoxysilane, 3-(methacryloyloxy)propyldimethylethoxysilane, vinyldimethylethoxysilane, phenyltrimethoxysilane, n-octyltrimethoxysilane, dodecyltrimethoxysilane, octadecyltrimethoxysilane, propyltrimethoxysilane, hexyltrimethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, styrylethyltrimethoxysilane, mercaptopropyltrimethoxysilane, 3-glycidoxypropyltrimethoxysilane, acrylic acid, methacrylic acid, oleic acid, stearic acid, dodecanoic acid, 2-[2-(2-methoxyethoxy)ethoxy]acetic acid (MEEAA), beta-carboxyethylacrylate, 2-(2-methoxyethoxy)acetic acid, methoxyphenyl acetic acid, and mixtures thereof. In some embodiments, a proprietary silane surface modifier identified by the trade name “Silquest A1230” (commercially available from OSI Specialties, Crompton South Charleston, W. Va.), may be used.

The surface modification of the particles in the colloidal dispersion can be accomplished in a variety of ways. Generally, the process involves mixing an inorganic dispersion with surface treatment agents. Optionally, a co-solvent may be added, e.g., 1-methoxy-2-propanol, ethanol, isopropanol, ethylene glycol, N,N-dimethylacetamide, ethyl acetate, and/or 1-methyl-2-pyrrolidinone. The co-solvent can enhance the solubility of the surface treatment agents as well as the surface modified particles. The mixture comprising the inorganic sol and surface treatment agents is subsequently reacted at room or an elevated temperature, with or without mixing. In some embodiments, the mixture can be reacted at about 80° C. for about 16 hours, resulting in the surface modified sol. In some embodiments, e.g., where heavy metal oxides are surface modified, the surface treatment of the metal oxide may involve the adsorption of acidic molecules to the particle surface. The surface modification of the heavy metal oxide may take place at room temperature.

The surface modification of zirconia with silanes can be accomplished under acidic conditions or basic conditions. In some embodiments, silanes are heated under acid conditions for a suitable period of time, at which time the dispersion is combined with aqueous ammonia (or other base). This method allows removal of the acid counter ion from the zirconia surface as well as reaction with the silane. In some embodiments, the particles are precipitated from the dispersion and separated from the liquid phase.

The surface modified particles can then be combined with the other components of the resin system (e.g., the crosslinkable resin and the reactive diluent) using any of a variety of methods. In some embodiments, a solvent exchange procedure is used whereby the crosslinkable resin and/or the reactive diluent is added to the surface modified sol, followed by removal of the water and co-solvent (if used) via evaporation, thus leaving the particles dispersed in the crosslinkable resin and/or the reactive diluent. The evaporation step can be accomplished for example, via distillation, rotary evaporation or oven drying. In some embodiments, the surface modified particles can be extracted into a water immiscible solvent followed by solvent exchange, if so desired.

Alternatively, another method for incorporating the surface modified nanoparticles in one or more of the other components of the resin system involves the drying of the modified particles into a powder, followed by the dispersion of this powder into one or more of the reactive diluent, cross-linkable resin and a solvent. The solvent can be acetone or ethanol. The drying step in this method can be accomplished by conventional means suitable for the system, such as, for example, oven drying, gap drying or spray drying.

In some embodiments, substrates having a cured gel coat layer attached thereto are used to create various articles. The cured gel coat layer includes the reaction product of a resin system as previously disclosed. For curing gel coats, the reactive surface modified nanoparticles, crosslinkable resin and reactive diluent can be reacted by a free radical polymerization mechanism at temperatures of about 50° C. or lower. Generally, the initiator includes both an initiator compound and an activator or promoter. Preferred initiators include various organic peroxides and peracids. Examples of initiators that cure at a temperature of about 50° C. or less include benzoyl peroxide, methyl ethyl ketone hydroperoxide, and cumene hydroperoxide. Preferably, the initiator is added at 1-3% based on the organic portion of the formulation. Activators such as cobalt octoate, cobalt 2-ethylhexanoate, and cobalt naphthenate are suitable for working with the peroxides to initiate cure. Non-cobalt containing promoters such as dimethylacetoacetamide may also be used. Preferably, activators and promoters are added at less than 1% based on the organic portion of the total formulation.

The substrate may be a fibrous reinforced composite, which can include one or more layers of random or structured fibers in a curable resin. Exemplary structured fibers include fabrics, woven and nonwoven webs, knits, scrims, and the like. In some embodiments, the article can be a vehicle (e.g., watercraft, aircraft, or a recreational vehicle), a fixture (e.g., a sink, a shower, a spa, or a bath tub), or any other composite having one or more layers of a reinforced resin. The cured gel coat can be directly or indirectly attached to the substrate. When the cured gel coat is indirectly attached to the substrate, there may be optional layers, e.g. barrier coatings, syntactic coatings, etc., between the cured gel coat and the substrate. When the cured gel coat is directly attached to the substrate, there may be other coatings over the outer surface of the cured coat layer.

The following specific, but non-limiting, examples will serve to illustrate the invention. In these examples, all percentages are parts by weight unless otherwise indicated.

### Test Methods

### Thermogravimetric Analysis (TGA)

Thermogravimetric analysis was run using a TA Instruments Model Q500 TGA and its associated software (available from TA Instruments, New Castle, Del.) employing a temperature ramp rate of 20 degrees Celsius (° C.)/minute from 35-900° C. in an air atmosphere.

### Gas Chromatography (GC)

Gas chromatography was run using an Agilent 6890 gas chromatograph equipped with an HP-5 column ((5% phenyl)-methylpolysiloxane) having a length of 30 meters and an inside diameter of 320 micrometers (both the chromatograph and column are available from Agilent Technologies, Incorporated, Santa Clara, Calif.). The following parameters were employed: a 1 microliter aliquot of a 10% sample solution (in tetrahydrofuran) was injected; split inlet mode set at 250° C., 9.52 psi and a total flow of 111 mL/min; column constant pressure mode set at 9.52 psi; velocity was set at 34 centimeters/second; gas flow was 2.1 mL/min; detector and injector temperatures were 250° C.; and a temperature sequence of equilibration at 40° C. for 5 minutes followed by a ramp rate of 20° C./minute to 200° C.

### Fracture Toughness

Fracture toughness of cured gel coat resins was measured according to ASTM D 5045-99 using a compact tension geometry wherein the specimens had nominal dimensions of 3.18 cm by 3.05 cm by 0.64 cm (1.25 in. by 1.20 in. by 0.25 in.). The following parameters were employed: W=2.54 cm (1.00 in.); a=1.27 cm (0.50 in.); B=0.64 cm (0.25 in.). In addition, a modified loading rate of 0.13 cm/minute (0.050 inches/minute) was used. Measurements were made on between 6 and 10 specimen for each gel coat resin tested. Average values for both K_{q} and K_{IC} were reported in units of MegaPascals times the square root of meters, i.e., MPa(m^{1/2}), along with the number of samples used and standard deviation. Only those samples meeting the validity requirements were used in the calculations.

### Neat Resin Tensile

The tensile properties of Examples 14-19, CE 4 and CE 5 were tested at room temperature in accordance with ASTM D638. An MTS/SinTech 5/GL test machine (SinTech, A Division of MTS Systems, Inc., P.O. Box 14226, Research Triangle Park, N.C. 27709-4226) was used, and an extensometer with a gage length of one inch. Specimen test sections were nominally 4″ long×¾″ wide×⅛″ thick and the loading rate was 0.20 in/min.

### Brookfield Viscometer

A Brookfield viscometer, Model DV-II+ (Brookfield Eng Labs, Inc. Stoughton, Mass. 02072), was used to measure resin viscosity at room temperature. A #4 spindle was used at 5 rpm and at 50 rpm. Readings were taken approximately 30 seconds after the motor was turned on. If use of the #4 spindle resulted in off-scale readings, other spindles were used instead. The Thixotropic Index (TI) was taken to be the ratio of the viscosity measured at 5 rpm divided by the viscosity measured at 50 rpm. Units are centipoise.

### Barcol Hardness

Barcol Hardness of cured gel coat resins was measured according to ASTM D 2583-95 (Reapproved 2001). A Barcol Impressor (Model GYZJ-934-1, available from Barber-Colman Company, Leesburg, Va.) was used to make measurements on specimens having a nominal thickness of 0.64 cm (0.25 in.). For each sample, between 5 and 10 measurements were made and the average value reported.

For Examples 1-6 and Comparative Examples 1 and 2, initial measurements on room temperature cured materials were made using the fracture toughness samples after they had been broken for that testing. The broken pieces were then thermally post cured for one hour in an oven at 125° C. and, after allowing them to cool to room temperature, hardness was again measured. For Examples 7-13, measurements were made on the samples that had been evaluated for flexural modulus after that testing was completed.

### Shear Modulus (G′)

Shear modulus (G′) of cured gel coat resins was measured using a theological dynamic analyzer (Model RDA2, available from Rheometrics Scientific, Incorporated, Piscataway, N.J.) using torsion rectangular geometry in a dynamic mode over the temperature range of 0-150° C. at a ramp rate of 5° C./minute, a frequency of 1 Hz and a strain of 0.1%. Specimen dimensions were nominally 3.81 cm long by 1.27 cm wide by 0.16 cm thick (1.5 inches long×0.50 inches wide×0.0625 inches thick). The shear modulus at 25° C. from the first scan was reported in GigaPascals (GPa).

### Flexural Modulus (E′) and Glass Transition Temperature (Tg)

Flexural storage modulus, E′, of cured gel coat resins was measured using an RSA2 Solids Analyzer (available from Rheometrics Scientific Inc., Piscataway, N.J.) in a dual cantilever beam mode. The specimen dimensions had nominal measurements of 50 millimeters long by 6 millimeters wide by 1.5 millimeters thick. A span of 40 millimeters was employed. Two scans were run, the first having a temperature profile of −25° C. to +125° C. at 5° C./minute, and the second scan having a temperature profile of −25° C. to +150° C. 5° C./minute. Both scans employed a temperature ramp of at 5° C./minute, a frequency of 1 Hertz and a strain of 0.1%. The sample was cooled after the first scan using a refrigerant at an approximate rate of 20° C./minute after which the second scan was immediately run. The flexural modulus, E′, at +25° C. on the second scan was reported. The tan delta peak of the second scan was reported as the glass transition temperature (Tg).

Materials

| | |
|---|---|
| AMBERLITE | Gel-type cation exchange resin that is commercially available |
| IR-120H PLUS | from Alfa Aesar (Ward Hill, Massachusetts) or Sigma-Aldrich |
| | Chemical Company (Milwaukee, Wisconsin). The cation |
| | exchange resin has sulfonic acid functionality and is in the |
| | hydrogen form. |
| Silica | Silica nanoparticle water-based sol (approximately 40 wt. % |
| Nanoparticle 1 | solids), pH = 9.3 at 25° C., ammonium stabilized, containing 40 wt. |
| | % silica based on the weight of the sol, having an average particle |
| | size of 22 nanometers and water-like viscosity, and a translucent |
| | appearance, obtained from Ondeo-Nalco Company, Naperville, |
| | Illinois as NALCO 2327, Lot# BP4M0648A2. |
| Silica | Silica nanoparticle water-based sol (approximately 40 wt. % |
| Nanoparticle 2 | solids), pH = 8.4 at 25° C., sodium counterion, containing 40 wt. % |
| | silica based on the weight of the sol, having an average particle |
| | size of 77 nanometers water-like viscosity, and a milky white |
| | appearance, obtained from Ondeo-Nalco Company, Naperville, |
| | Illinois as NALCO 2329, Lot# BP5J0010A1. |
| Silica | Silica nanoparticle water-based sol (approximately 40 wt. % |
| Nanoparticle 3 | solids), pH = 8.4 at 25° C., sodium counterion, containing 40 wt. % |
| | silica based on the weight of the sol, having an average particle |
| | size of 107 nanometers and water-like viscosity, and a milky white |
| | appearance, obtained from Ondeo-Nalco Company, Naperville, |
| | Illinois as NALCO 2329, Lot# BP5G0441A1. |
| Silica | Silica nanoparticle water-based sol (approximately 40 wt. % |
| Nanoparticle 4 | solids), pH = 8.4 at 25° C., sodium counterion, containing 40 wt. % |
| | silica based on the weight of the sol, having an average particle |
| | size 75 nanometers, a water-like viscosity, and a milky white |
| | appearance, obtained from Ondeo-Nalco Company, Naperville, |
| | Illinois as NALCO 2329, Lot# BP7A0228A1. |
| Methoxy | 1-methoxy-2-propanol, obtained from Ashland Chemical |
| Propanol | Company, Dublin, Ohio. |
| A174 Silane | [3-(methacryloxy)propyl]trimethoxy silane, molecular weight = |
| | 248.3 grams/mole, obtained from Alfa Aesar ®, Ward Hill, |
| | Massachusetts. |
| PEG-Silane | The reaction product of 3-triethoxysilylpropyl isocyanate and |
| | poly(ethylene glycol) methyl ether, molecular weight = 797 |
| | grams/mole, prepared as described below. |
| A1230 Silane | SILQUEST ® A-1230 Silane, a proprietary, non-ionic |
| | polyalkyleneoxide alkoxy silane, determined to have a molecular |
| | weight of approximately 500 grams/mole, available from GE |
| | Advanced Materials - Silicones, South Charleston, West Virginia |
| | and OSI Specialties, Greenwich, Connecticut. |
| CLM Silane | Caprolactone methacrylate silane (C₂₂H₄₁O₉NSi), molecular |
| | weight = 491 grams/mole, prepared as described below. |
| PROSTAB | a hindered amine nitroxide inhibitor, available from Ciba |
| 5198 | Specialty Chemical, Incorporated, Tarrytown, New York. |
| Disperbyk 110 | A dispersing additive commercially available from BYK Chemie, |
| | USA Wallingford, CT. |
| Tipure R960 | Titania pigment commercially available from Dupont, |
| | Wilmington, DE. |
| Styryl Silane | Styrylethyl trimethoxysilane, available from Gelest Incorporated, |
| | Morrisville, Pennsylvania. |
| Gel Coat Base | a gel coat composition obtained from Mini-Craft ® of Florida, |
| Resin 1 | Incorporated, Wildwood, Florida as “Marine Clear Gel Kote - |
| | Silver Series” (GL)761C30201, and comprised of a (isophthalic |
| | acid/neopentyl glycol/maleic and fumaric acid)- derived |
| | copolymer, styrene (about 40 wt. %), cobalt naphthenate, and about |
| | 5 wt. % fumed silica. |
| 3M Gel Coat | a gel coat composition obtained from Mini-Craft ® of Florida, |
| Base Resin 2 | Incorporated, Wildwood, Florida for 3M Company, and comprised |
| | of a (isophthalic acid/neopentyl glycol/maleic and fumaric |
| | acid)- derived copolymer, styrene (about 40 wt. %). |
| 3M Gel Coat | a gel coat composition obtained from Mini-Craft ® of Florida, |
| Base Resin 3 | Incorporated, Wildwood, Florida for 3M Company, and |
| | comprised of a (isophthalic acid/neopentyl glycol/maleic and |
| | fumaric acid)- derived copolymer, styrene (about 40 wt. %) |
| MEKP | methylethylketone peroxide, available as 2-butanone peroxide, ca. |
| | 35 wt. % solution in 2,2,4-trimethyl-1,3-pentanediol diisobutyrate, |
| | from Sigma-Aldrich Chemical Company, Milwaukee, Wisconsin. |
| Cobalt | a 6 wt. % solution of cobalt naphthenate, available from Mini-Craft |
| Naphthenate | of Florida, Incorporated, Wildwood, Florida. |
| solution | |

Preparation of Poly(ethylene glycol)-Silane (PEG-Silane)

Forty-one grams of 3-triethoxysilylpropyl isocyanate (available from Sigma-Aldrich Chemical Company, Milwaukee, Wis.) was added over a five minute period to a mixture of poly(ethylene glycol)methyl ether (96 grams, molecular weight=500 grams/mole, dried over molecular sieves) and four drops of tin(dibutyl dilaurate) (available from Strem Chemicals, Newburyport, Mass.) in an amber jar. The resulting mixture was stirred overnight. The consumption of all of the isocyanate was confirmed by obtaining an infrared (IR) spectrum of the resulting liquid to confirm the absence of NCO peaks.

Preparation of Caprolactone methacrylate silane (CLMS)

Seventy-two grams of 3-triethoxysilylpropyl isocyanate was added over a 5-10 minute period to a stirred mixture of 75 grams caprolactone-2-(methacryloyloxy)ethyl ester (molecular weight=244 grams/mole, dried over molecular sieves) and 3 drops of tin(dibutyl dilaurate). The resulting exotherm was kept below 40° C. by means of a water bath. The resulting mixture was stirred overnight. The consumption of all of the isocyanate was confirmed by obtaining an IR spectrum of the resulting liquid to confirm the absence of NCO peaks.

### Preparation of Reactive, Surface Modified Nanoparticles

### Ion Exchange Resin Treatment

For Examples 1-6 the aqueous silica nanoparticle sols were all treated with a cation exchange resin before further use. More specifically, aqueous silica sol was stirred in a PYREX glass beaker at room temperature (i.e., 20 to 25° C.) and prewashed Amberlite™ IR-120H Plus cation exchange resin was slowly added until the pH measured between 2 and 3 using pH paper. This mixture was stirred an additional 30 minutes then filtered through a nylon mesh having a mesh opening of approximately 53 micrometers (available as SPECTRA/MESH 270 from Spectrum Laboratories, Incorporated, Laguna Hills, Calif.) to remove the ion exchange resin and provide a treated nanoparticle sol. The solids content was determined and found to range from 40 to 41.5%.

### Reactive, Surface Modified Nanoparticles 1A

Four hundred grams of ion exchange treated Silica Nanoparticle 1 sol was placed in a round bottom flask. Under medium agitation, 200 grams of 1-methoxy-2-propanol was added followed by the quick addition of enough aqueous ammonium hydroxide to bring the pH to between 9 and 9.5 without gelation. A premixed solution of 350 grams of 1-methoxy-2-propanol, 12.0 grams of A174 Silane (0.048 moles silane) and 23.8 grams (0.048 moles silane) of A1230 Silane was then added. The resulting mixture was heated at 90 to 95° C. for approximately 20 to 22 hours and then air dried to a white, free-flowing solid. Thermogravimetric analysis of the powder indicated a silica content of 84.6%.

The silane-treated silica powder was dispersed in acetone using a high shear Silverson L4R mixer (available from Silverson Machines, Limited, Chesham, England) set at three-quarters speed for between 1 and 2 minutes. The resulting silica/acetone mixture was covered, allowed to sit for at least one hour, and then filtered through a nylon mesh having a mesh opening of approximately 53 micrometers (available as SPECTRA/MESH 270) to give a dispersion having a hazy white appearance and a viscosity like that of water. The surface modified silica/acetone mixture was dried in an 80° C. oven and found to be 18.9% solids. Based on TGA data the calculated “silica only” content of the acetone mixture was 16.0%.

### Reactive, Surface Modified Nanoparticles 1B

Four hundred grams of Silica Nanoparticle 1 sol was placed in a quart-sized glass jar. A premixed solution of 450 grams of 1-methoxy-2-propanol, 12.74 grams of A174 Silane (0.0514 moles silane) and 25.68 grams (0.0514 moles) of A1230 Silane was then added. The jar was sealed and the resulting mixture was heated in an oven set at 80° C. for approximately 16 hours to give a sol containing reactive, surface modified nanoparticles. A small sample was removed and oven dried at 120° C. for about 30 minutes to a white, free-flowing solid. Thermogravimetric analysis of the powder indicated a silica content of 81.6%.

### Reactive, Surface Modified Nanoparticles 2A

Four hundred grams of ion exchange treated Silica Nanoparticle 2 sol was placed in a round bottom flask. Under medium agitation, 100 grams of 1-methoxy-2-propanol was added followed by the quick addition of enough aqueous ammonium hydroxide to bring the pH to between 9 and 9.5 without gelation. A premixed solution of 350 grams of 1-methoxy-2-propanol, 3.16 grams (0.0127 moles silane) of A174 Silane and 10.2 grams (0.0127 moles silane) of PEG-Silane was then added. The resulting mixture was heated at 90 to 95° C. for approximately 20 to 22 hours and then air dried to a white, free-flowing solid. Thermogravimetric analysis of the powder indicated a silica content of 92.6%.

The silane-treated silica powder was dispersed in acetone using a high shear Silverson L4R mixer (available from Silverson Machines, Limited, Chesham, England) set at three-quarters speed for between 1 and 2 minutes. The resulting silica/acetone mixture was covered, allowed to sit for at least one hour, and then filtered through a nylon mesh having a mesh opening of approximately 53 micrometers (available as SPECTRA/MESH 270) to give a dispersion having an opaque white appearance and a viscosity like that of water. The surface modified silica/acetone mixture was dried in an 80° C. oven and found to be 21.0% solids. Based on TGA data the calculated “silica only” content of the acetone mixture was 19.4%.

### Reactive, Surface Modified Nanoparticles 2B

Four hundred and fifty grams of ion exchange treated Silica Nanoparticle 2 sol was placed in a round bottom flask. Under medium agitation, 200 grams of 1-methoxy-2-propanol was added followed by the quick addition of enough aqueous ammonium hydroxide to bring the pH to between 9 and 9.5 without gelation. A premixed solution of 500 grams of 1-methoxy-2-propanol and 14 grams of CLM Silane (0.029 moles) was then added. The resulting mixture was heated at 90 to 95° C. for approximately 20 to 22 hours and then air dried to a white, free-flowing solid. Thermogravimetric analysis of the powder indicated a silica content of 92.2%.

The silane-treated silica powder was dispersed in acetone using a high shear Silverson L4R mixer (available from Silverson Machines, Limited, Chesham, England) set at three-quarters speed for between 1 and 2 minutes. The resulting silica/acetone mixture was covered, allowed to sit for at least one hour, and then filtered through a nylon mesh having a mesh opening of approximately 53 micrometers (available as SPECTRA/MESH 270) having an opaque white appearance and a viscosity like that of water. The surface modified silica/acetone mixture was dried in an 80° C. oven and found to be 17.2% solids. Based on TGA data the calculated “silica only” content of the acetone mixture was 15.8%.

### Reactive, Surface Modified Nanoparticles 2C

Four hundred grams of Silica Nanoparticle 2 sol was placed in a quart-sized glass jar. A premixed solution of 450 grams of 1-methoxy-2-propanol, 2.91 grams of A174 Silane (0.0117 moles silane) and 5.86 grams (0.0117 moles) of A1230 Silane was then added. The jar was sealed and the resulting mixture was heated in an oven set at 80° C. for approximately 16 hours to give a sol containing reactive, surface modified nanoparticles. A small sample was removed and oven dried at 120° C. for about 30 minutes to a white, free-flowing solid. Thermogravimetric analysis of the powder indicated a silica content of 94.3%.

### Reactive, Surface Modified Nanoparticles 3A

Four hundred grams of ion exchange treated Silica Nanoparticle 3 sol was placed in a round bottom flask. Under medium agitation, 200 grams of 1-methoxy-2-propanol was added followed by the quick addition of enough aqueous ammonium hydroxide to bring the pH to between 9 and 9.5 without gelation. A premixed solution of 500 grams of 1-methoxy-2-propanol, 2.3 grams (0.009 moles silane) of A174 Silane and 7.3 grams (0.009 moles silane) of PEG-Silane was then added. The resulting mixture was heated at 90 to 95° C. for approximately 20 to 22 hours and then air dried to a white, free-flowing solid. Thermogravimetric analysis of the powder indicated a silica content of 93.4%.

The silane-treated silica powder was dispersed in acetone using a high shear Silverson L4R mixer (available from Silverson Machines, Limited, Chesham, England) set at three-quarters speed for between 1 and 2 minutes. The resulting silica/acetone mixture was covered, allowed to sit for at least one hour, and then filtered through a nylon mesh having a mesh opening of approximately 53 micrometers (available as SPECTRA/MESH 270) having an opaque white appearance and a viscosity like that of water. The surface modified silica/acetone mixture was dried in an 80° C. oven and the % solids found to be 17.5%. Based on TGA data the calculated “silica only” content of the acetone mixture was 16.3%.

### Reactive, Surface Modified Nanoparticles 3B

Five hundred grams of ion exchange treated Silica Nanoparticle 3 sol was placed in a round bottom flask. Under medium agitation, 200 grams of 1-methoxy-2-propanol was added followed by the quick addition of enough aqueous ammonium hydroxide to bring the pH to between 9 and 9.5 without gelation. A premixed solution of 600 grams of 1-methoxy-2-propanol, 6.04 grams of A174 Silane (0.0243 moles silane) and 0.025 grams of a 5% PROSTAB 5198 solution was then added. The resulting mixture was heated at 90 to 95° C. for approximately 20 to 22 hours and then air dried to a white, free-flowing solid. Thermogravimetric analysis of the powder indicated a silica content of 96.3%.

The silane-treated silica powder was dispersed in acetone using a high shear Silverson L4R mixer (available from Silverson Machines, Limited, Chesham, England) set at three-quarters speed for between 1 and 2 minutes. The resulting silica/acetone mixture was covered, allowed to sit for at least one hour, and then filtered through a nylon mesh having a mesh opening of approximately 53 micrometers (available as SPECTRA/MESH 270) having an opaque white appearance and a viscosity like that of water. The surface modified silica/acetone mixture was dried in an 80° C. oven and the % solids found to be 22%. Based on TGA data the calculated “silica only” content of the acetone mixture was 21.2%.

### Reactive, Surface Modified Nanoparticles 3C

Five hundred grams of ion exchange treated Silica Nanoparticle 3 sol was placed in a round bottom flask. Under medium agitation, 200 grams of 1-methoxy-2-propanol was added followed by the quick addition of enough aqueous ammonium hydroxide to bring the pH to between 9 and 9.5 without gelation. A premixed solution of 600 grams of 1-methoxy-2-propanol, 11.95 grams of CLM silane (0.0243 moles silane) and 0.048 grams of a 5% PROSTAB 5198 solution was then added. The resulting mixture was heated at 90 to 95° C. for approximately 20 to 22 hours and then air dried to a white, free-flowing solid. Thermogravimetric analysis of the powder indicated a silica content of 94.5%.

The silane-treated silica powder was dispersed in acetone using a high shear Silverson L4R mixer (available from Silverson Machines, Limited, Chesham, England) set at three-quarters speed for between 1 and 2 minutes. The resulting silica/acetone mixture was covered, allowed to sit for at least one hour, and then filtered through a nylon mesh having a mesh opening of approximately 53 micrometers (available as SPECTRA/MESH 270) having an opaque white appearance and a viscosity like that of water. The surface modified silica/acetone mixture was dried in an 80° C. oven and the % solids found to be 21.6%. Based on TGA data the calculated “silica only” content of the acetone mixture was 20.4%.

### Reactive, Surface Modified Nanoparticles 3D

Four hundred grams of Silica Nanoparticle 3 sol was placed in a quart-sized glass jar. A premixed solution of 450 grams of 1-methoxy-2-propanol, 2.14 grams of A174 Silane 0.0086 moles silane) and 4.3 grams (0.0086 moles) of A1230 Silane was then added. The jar was sealed and the resulting mixture was heated in an oven set at 80° C. for approximately 16 hours to give a sol containing reactive, surface modified nanoparticles. A small sample was removed and oven dried at 120° C. for about 30 minutes to a white, free-flowing solid. Thermogravimetric analysis of the powder indicated a silica content of 96.0%.

### Reactive, Surface Modified Nanoparticles 3E

Four hundred grams of Silica Nanoparticle 3 sol was placed in a quart-sized glass jar. A premixed solution of 450 grams of 1-methoxy-2-propanol, 8.45 grams of CLM silane (0.0172 moles silane) was then added. The jar was sealed and the resulting mixture was heated in an oven set at 80° C. for approximately 16 hours to give a sol containing reactive, surface modified nanoparticles. A small sample was removed and oven dried at 120° C. for about 30 minutes to a white, free-flowing solid. Thermogravimetric analysis of the powder indicated a silica content of 94.5%.

### Reactive, Surface Modified Nanoparticles 3F

Four hundred grams of Silica Nanoparticle 3 sol was placed in a quart-sized glass jar. A premixed solution of 450 grams of 1-methoxy-2-propanol, 4.23 grams of CLM silane (0.00862 moles silane) and 4.30 grams of A1230 Silane (0.00862 moles silane) was then added. The jar was sealed and the resulting mixture was heated in an oven set at 80° C. for approximately 16 hours to give a sol containing reactive, surface modified nanoparticles. A small sample was removed and oven dried at 120° C. for about 30 minutes to a white, free-flowing solid. Thermogravimetric analysis of the powder indicated a silica content of 94.5%.

### Reactive, Surface Modified Nanoparticles 3G

Four hundred grams of Silica Nanoparticle 3 sol was placed in a quart-sized glass jar. A premixed solution of 450 grams of 1-methoxy-2-propanol, 2.23 grams of styryl silane (0.00862 moles silane) and 4.30 grams of A1230 Silane (0.00862 moles silane) was then added. The jar was sealed and the resulting mixture was heated in an oven set at 80° C. for approximately 16 hours to give a sol containing reactive, surface modified nanoparticles. A small sample was removed and oven dried at 120° C. for about 30 minutes to a white, free-flowing solid. Thermogravimetric analysis of the powder indicated a silica content of 95.9%.

### Reactive, Surface Modified Nanoparticles 3H

Four hundred grams of Silica Nanoparticle 3 sol was placed in a quart-sized glass jar. A premixed solution of 450 grams of 1-methoxy-2-propanol, 8.45 grams of CLM silane (0.0172 moles silane) was then added. The jar was sealed and the resulting mixture was heated in an oven set at 80° C. for approximately 16 hours to give a sol containing reactive, surface modified nanoparticles. A small sample was removed and oven dried at 120° C. for about 30 minutes to a white, free-flowing solid. Thermogravimetric analysis of the powder indicated a silica content of 94.5%.

### Reactive, Surface Modified Nanoparticles 4A

Four hundred grams of Silica Nanoparticle 4 sol was placed in a quart-sized glass jar. A premixed solution of 450 grams of 1-methoxy-2-propanol, 3.10 grams A174 silane and 6.24 grams Silquest A1230 was then added with stirring. The jar was sealed and the resulting mixture was heated in an oven set at 80° C. for approximately 16 hours to give a sol containing reactive, surface modified nanoparticles. A total of 6 jars were prepared with this method. The jars were then concentrated by rotary evaporation to 65-70% solids and combined. The resultant concentrated surface modified nanoparticle dispersion was then dried according to the procedures described in U.S. Pat. No. 5,980,697 (Kolb et al.) and U.S. Pat. No. 5,694,701 (Huelsman, et al.), with a dispersion coating thickness of about 0.25 mm (10 mils) and a residence time of 1.6 minutes (heating platen temperature 107° C., and condensing platen temperature 21° C.) to yield a fine, free-flowing white powder.

### Reactive, Surface Modified Nanoparticles 4B

Four hundred grams of Silica Nanoparticle 4 sol was placed in a quart-sized glass jar. A premixed solution of 450 grams of 1-methoxy-2-propanol, 4.64 grams A174 silane and 3.12 grams Silquest A1230 was then added with stirring. The jar was sealed and the resulting mixture was heated in an oven set at 80° C. for approximately 16 hours to give a sol containing reactive, surface modified nanoparticles. A total of 6 jars were prepared with this method. The jars were then concentrated by rotary evaporation to 65-70% solids and combined. The resultant concentrated surface modified nanoparticle dispersion was then dried to yield a fine, free-flowing white powder as described above.

### Reactive, Surface Modified Nanoparticles 4C

Four hundred grams of Silica Nanoparticle 4 sol was placed in a quart-sized glass jar. A premixed solution of 450 grams of 1-methoxy-2-propanol and 12.49 grams Silquest A1230 was then added with stirring. The jar was sealed and the resulting mixture was heated in an oven set at 80° C. for approximately 16 hours to give a sol containing reactive, surface modified nanoparticles. A total of 6 jars were prepared with this method. The jars were then concentrated by rotary evaporation to 65-70% solids and combined. The resultant concentrated surface modified nanoparticle dispersion was then dried to yield a fine, free-flowing white powder as described above.

### Reactive, Surface Modified Nanoparticles 4D

Four hundred grams of Silica Nanoparticle 4 sol was placed in a quart-sized glass jar. A premixed solution of 450 grams of 1-methoxy-2-propanol and 12.26g CLM Silane was added with stirring. The jar was sealed and the resulting mixture was heated in an oven set at 80° C. for approximately 16 hours to give a sol containing reactive, surface modified nanoparticles. A total of 6 jars were prepared with this method. The jars were then concentrated by rotary evaporation to 65-70% solids and combined. The resultant concentrated surface modified nanoparticle dispersion was then dried to yield a fine, free-flowing white powder as described above.

### Reactive, Surface Modified Nanoparticles 4E

Four hundred grams of Silica Nanoparticle 4 sol was added to a quart size jar. A premixed solution of 450 g 1-Methoxy-2-Propanol and 6.193 g A 174 silane was slowly added to the jar with stirring. The jar was sealed and placed in an oven for 16 hours at 80 C. A total of 6 jars were made with this method. The jars were then concentrated by rotary evaporation to 65-70% solids and combined. The resultant concentrated surface modified nanoparticle dispersion was then dried to yield a fine, free-flowing white powder as described above.

Preparation of Gel Coat Base Resins with Reactive, Surface Modified Nanoparticles

### Example 1

To a glass jar were added 112 grams of Gel Coat Base Resin 1 and 467 grams of Reactive, Surface Modified Nanoparticles 1A/acetone mixture, and 0.18 grams of a 5% aqueous solution of Prostab® 5198 inhibitor (200 parts per million (ppm) based on the styrene portion of the base gel coat resin). The jar was sealed and shaken well by hand. The resulting dispersion was vacuumed stripped (Buchi rotary evaporator with a water aspirator) at a temperature of 40° C. for 30 minutes to remove the majority of the solvents. Once a majority of the acetone had been removed the material was placed in several small plastic cups filled approximately one-half to three-quarters full, and put in a vacuum oven at 40° C. and further stripped. During this stripping process the vacuum was periodically broken (e.g., about every 30 minutes) and the samples were stirred well and the vacuum re-established. This was done until the acetone level was found to be less than 1 wt. % as measured by gas chromatography. Styrene was then back-added to provide a final styrene content of 40 wt. % based on the gel coat base resin only (i.e., without the nanoparticles) as determined by gas chromatography. The resulting nanoparticle-containing gel coat resin system had a somewhat clear, brown-colored viscous appearance. It was evaluated by TGA and found to have a “silica only” content of about 41 wt. % (including the fumed silica contained in Gel Coat Base Resin 1).

The nanoparticle-containing gel coat resin system obtained was used to prepare samples for evaluation as follows. A plastic beaker was filled to one-third volume with the resin and 1.0 wt. % (based on total weight of the nanoparticle-containing gel coat resin) of methylethylketone peroxide (MEKP) solution (ca. 35 wt. % solids) was added. After stirring under vacuum (pump) for about one minute the resin was transferred to a float glass mold treated with Valspar MR 225 release material (available from Sher-Fab Unlimited, Incorporated, Norwalk, Calif.) and allowed to cure at room temperature for 175 days. The nominal inside dimensions of the mold were 2.54 cm high by 5.08 cm wide by 0.16 cm thick (1 inch high by 2 inches wide by 0.062 inches thick). After curing, samples were prepared and evaluated for shear modulus.

### Example 2

Example 1 was repeated with the following modifications. Three hundred and eighty-six grams of Reactive, Surface Modified Nanoparticles 2A/acetone mixture were used in place of the Reactive, Surface Modified Nanoparticles 1A/acetone mixture. The resulting nanoparticle-containing gel coat resin system had an opaque, aqua-colored appearance with a viscosity like that of petroleum jelly. It was evaluated by TGA and found to have a “silica only” content of about 42 wt. % (including the fumed silica contained by the starting gel coat base resin).

### Example 3

Example 1 was repeated with the following modifications. One hundred and twenty-five grams of Gel Coat Base Resin 1, 633 grams of Reactive, Surface-modified Nanoparticles 2B/acetone mixture were used in place of the Reactive, Surface-modified Nanoparticles 1A/acetone mixture, and 0.2 grams of a 5% aqueous solution of PROSTAB 5198 inhibitor were employed. The resulting nanoparticle-containing gel coat had an opaque, gray-colored appearance with a viscosity like that of petroleum jelly. It was evaluated by TGA and found to have a “silica only” content of about 42 wt. % (including the fumed silica contained in Gel Coat Base Resin 1). The samples were allowed to cure at room temperature for 15 days. The nominal inside dimensions of the mold were 3.5 inches high by 7 inches wide by 0.25 inches thick.

### Example 4

Example 1 was repeated with the following modifications. Four hundred and fifty-seven grams of Reactive, Surface-modified Nanoparticles 3A/acetone mixture, were used in place of the Reactive, Surface-modified Nanoparticles 1A/acetone mixture. The resulting nanoparticle-containing gel coat was viscous and had an opaque, aqua-colored appearance. It was evaluated by TGA and found to have a “silica only” content of about 43 wt. % (including the fumed silica contained in Gel Coat Base Resin 1). The resin was cured overnight at room temperature then post-cured at 125° C. for one hour and allowed to cool.

### Example 5

Example 3 was repeated with the following modifications. Two hundred and ten grams of Gel Coat Base Resin 1 were used. Also, 717 grams of Reactive, Surface-modified Nanoparticles 3B/acetone mixture were used in place of the Reactive, Surface-modified Nanoparticles 2B/acetone mixture, and 0.35 grams of a 5% aqueous solution of PROSTAB 5198 inhibitor were employed. The resulting nanoparticle-containing gel coat was viscous and had an opaque, blue/gray-colored appearance. It was evaluated by TGA and found to have a “silica only” content of about 44 wt. % (including the fumed silica contained in Gel Coat Base Resin 1). The samples were allowed to cure at room temperature for 19 days.

### Example 6

Example 3 was repeated with the following modifications. Two hundred and ten grams of Gel Coat Base Resin 1 were used, 745 grams of Reactive, Surface-modified Nanoparticles 3C/acetone mixture were used in place of the Reactive, Surface-modified Nanoparticles 2/acetone mixture, and 0.35 grams of a 5% aqueous solution of PROSTAB 5198 inhibitor were employed. The resulting nanoparticle-containing gel coat was viscous and had an opaque, blue/gray-colored appearance. It was evaluated by TGA and found to have a “silica only” content of about 44 wt. % (including the fumed silica contained by the starting gel coat base resin). The samples were allowed to cure at room temperature for 19 days.

### Comparative Example 1

A plastic beaker was filled to one-third volume with Gel Coat Base Resin 1 and 1.0% wt. % (based on total weight of the gel coat) of methylethylketone peroxide (MEKP) solution (ca. 35 wt. % solution) was added. After stirring under vacuum (pump) for about one minute the gel coat was transferred to a float glass mold treated with VALSPAR MR 225 release material and allowed to cure at room temperature for 175 days. The nominal inside dimensions of the mold were 2.54 cm high by 5.08 cm wide by 0.16 cm thick (1 inch high by 2 inches wide by 0.062 inches thick).

### Comparative Example 2

Comparative Example 1 was repeated with the following modifications. The nominal inside dimensions of the mold were 8.9 cm high by 18 cm wide by 0.63 cm thick (3.5 inches high by 7 inches wide by 0.25 inches thick). The sample was cured for 15 days.

Initial Barcol measurements on room temperature cured materials were made using the fracture toughness samples after they had been broken for that testing. The broken pieces were then thermally post cured for one hour in an oven at 125° C. and, after allowing them to cool to room temperature, hardness was again measured.

TABLE 1
Summary description of the reactive, surface-modified nanoparticles.

| | | Particle | |
|---|---|---|---|
| Ex. | Particles | Size (nm) | Silane Treatment |
| 1 | 1A | 22 | A174:A1230/1:1 |
| 2 | 2A | 77 | A174:PEG-Silane/1:1 |
| 3 | 2B | 77 | CLM Silane |
| 4 | 3A | 107 | A174:PEG-Silane/1:1 |
| 5 | 3B | 107 | A174 |
| 6 | 3C | 107 | CLM Silane |
| CE 1 | None | none | none |
| CE 2 | None | none | none |

Various mechanical properties of the cured gel coats of Examples 1-6 and Comparative Examples 1 and 2 were measured. The results are presented in Table 2.

TABLE 2
Summary of cure conditions and mechanical properties.

| | | | Barcol | Barcol | | | | | | |
|---|---|---|---|---|---|---|---|---|---|---|
| | Cure time | | Hardness | Hardness | | | | | | |
| | @ R.T. | G′ | (Cured at | (Thermal | Fracture Toughness (MPa(m^{1/2})) | | | | | |
| Ex. | (days) | (GPa) | R.T.) | Post Cure) | K_{q} | S.D. | n | K_{IC} | S.D. | N |
| 1 | 175 | 2.90 | ND | ND | ND | — | — | ND | — | — |
| 2 | 175 | 3.20 | ND | ND | ND | — | — | ND | — | — |
| 3 | 15 | ND | 60 | 65 | 1.03 | 0.04 | 10 | 0.94 | — | 1 |
| 4 | 175 | 3.75 | ND | ND | ND | — | — | ND | — | — |
| 5 | 19 | ND | 56 | 67 | 1.02 | 0.06 | 6 | ** | — | — |
| 6 | 19 | ND | 53 | 66 | 1.05 | 0.04 | 10 | 1.09 | 0.00 | 2 |
| CE 1 | 175 | 1.99 | ND | ND | ND | — | — | ND | — | — |
| CE 2 | 15 | ND | 32 | 39 | 0.51 | 0.03 | 9 | 0.51 | 0.01 | 5 |

S.D. = standard deviation
ND = not determined
n = number of specimens
** = no specimens met the K_{IC} validity requirements

### Example 7

To a 1 liter round bottomed flask were added 154.7 grams of Gel Coat Base Resin 2, 587 grams of Reactive, Surface-modified Nanoparticles 3D, and 0.60 grams of a 5% aqueous solution of PROSTAB 5198 inhibitor (200 ppm based on the total weight of Gel Coat Base Resin 2). The resulting dispersion was vacuumed stripped (Buchi rotary evaporator with a water aspirator) at a temperature of 50° C. for about 45 minutes to remove the majority of the solvent. When the dispersion became viscous it was removed from the evaporator and 100 grams of styrene was added. The resulting dispersion was placed back on the evaporator and stripped at 50° C. for about 15 minutes. When the evaporated dispersion became viscous it was removed from the evaporator and found to contain 4.9% 1-methoxy-2-propanol and 16.1% styrene as determined by gas chromatography (GC). Based on these results, 7 grams of water and 34 grams of styrene were added to the dispersion and it was placed back on the rotary evaporator. After about 15 minutes the further evaporated dispersion was viscous again and the above process repeated. The GC results indicated 2% 1-methoxy-2-propanol and 16.7% styrene. Another 36 grams of styrene and 3 grams of water were then added to the dispersion and it was placed back on the rotary evaporator. After an additional 15 minutes, the evaporated dispersion was viscous. Evaluation of the evaporated dispersion by GC indicated 0.9% 1-methoxy-2-propanol and 16.6% styrene. Accordingly, 21.2 grams of styrene was added to the dispersion. The resulting nanoparticle-containing gel coat had a viscous, white, translucent appearance. It was evaluated by TGA and found to have a “silica only” content of about 40 wt. %. To 254 grams of this material was added, with thorough mixing, 1.06 grams of cobalt naphthenate solution to provide 250 ppm of cobalt based on the weight of the nanoparticle-containing gel coat.

The resulting nanoparticle-containing gel coat was used to prepare samples for evaluation as follows. Into a wide-mouth plastic container having a lid was placed the resulting nanoparticle-containing gel coat and 1.0 wt. % (based on total weight of the nanoparticle-containing gel coat) of methylethylketone peroxide (MEKP) solution (ca. 35 wt. % solution) was added. The container was sealed and the contents mixed at 2000 revolutions/minute (rpm) for 30 seconds using a SpeedMixer™ dual asymmetric centrifuge (Model DAC 600 FVZ-sp, available from Flack Tek, Incorporated, Landrum, S.C.). After mixing the nanoparticle-containing gel coat was transferred to a float glass mold treated with VALSPAR MR 225 release material.

### Example 8

To a 1 liter round bottomed flask were added 152.7 grams of Gel Coat Base Resin 2 and 583 grams of Reactive, Surface-modified Nanoparticles 2C, and 0.60 grams of a 5% aqueous solution of PROSTAB 5198 inhibitor (200 ppm based on the total weight of Gel Coat Base Resin 2). The resulting dispersion was vacuumed stripped (Buchi rotary evaporator with a water aspirator) at a temperature of 50° C. for about 45 minutes to remove the majority of the solvent. When the dispersion became viscous it was removed from the evaporator and 100 grams of styrene was added and it was placed back on the evaporator. The resulting dispersion was vacuumed stripped at a temperature of 50° C. for about 15 minutes. When the evaporated dispersion became viscous it was removed from the evaporator, evaluated by GC and found to contain 3.0% 1-methoxy-2-propanol and 13.1% styrene. Based on this information, 50 grams of styrene and 5 grams of water (to provide an azeotrope for further solvent removal) were added to the dispersion and it was placed back on the rotary evaporator. After 15 minutes the further evaporated dispersion was viscous again and the above process repeated. The GC results indicated 1% 1-methoxy-2-propanol and 14.2% styrene. Another 26.8 grams of styrene was added to the dispersion. The resulting nanoparticle-containing gel coat had a viscous, white, translucent appearance. It was evaluated by TGA and found to have a “silica only” content of about 40 wt. %. To 252 grams of this material was added, with thorough mixing, 1.05 grams of cobalt naphthenate solution to provide 250 ppm of cobalt based on the weight of the nanoparticle-containing gel coat.

The resulting nanoparticle-containing gel coat was used to prepare samples for evaluation as follows. Into a wide-mouth plastic container having a lid was placed the resulting nanoparticle-containing gel coat and 1.0 wt. % (based on total weight of the nanoparticle-containing gel coat) of methylethylketone peroxide (MEKP) solution (ca. 35 wt. % solution) was added. The container was sealed and the contents mixed at 2000 revolutions/minute (rpm) for 30 seconds using a SpeedMixer™ dual asymmetric centrifuge (Model DAC 600 FVZ-sp, available from Flack Tek, Incorporated, Landrum, S.C.). After mixing the nanoparticle-containing gel coat was transferred to a float glass mold treated with VALSPAR MR 225 release material.

### Example 9

To a 1 liter round bottomed flask were added 619.4 grams of Reactive, Surface-modified Nanoparticles 1B. The dispersion was vacuumed stripped (Buchi rotary evaporator with a water aspirator) at a temperature of 50° C. for about 45 minutes to concentrate the dispersion. When the dispersion became viscous, it was removed from the evaporator. The concentration of the dispersion was now 53.8 wt. %. To this concentrated dispersion were added 120.3 grams of Gel Coat Base Resin 2 and 0.48 grams of a 5% aqueous solution of PROSTAB 5198 inhibitor (200 ppm based on the total weight of Gel Coat Base Resin 2). The flask was placed back on the rotary evaporator to remove the remainder of alcohol and water. When the dispersion became viscous, it was removed from the evaporator and evaluated by GC and found to contain 5.4% 1-methoxy-2-propanol and 13.9% styrene. Based on this information, 30 grams of styrene was added to the dispersion and it was placed back on the rotary evaporator. After 15 minutes the evaporated dispersion became viscous and the above process repeated. The GC results indicated 1.8% 1-methoxy-2-propanol and 15.6% styrene. Another 40 grams of styrene was added to the dispersion and it was placed back on the rotary evaporator. After 15 minutes the further evaporated dispersion was again viscous and the above process repeated. The GC results indicated 0.6% 1-methoxy-2-propanol and 15.0% styrene. Accordingly, 14.9 grams of styrene was added to the dispersion. The resulting nanoparticle-containing gel coat had a viscous, clear, transparent appearance. It was evaluated by TGA and found to have a “silica only” content of about 40 wt. %. To 233.7 grams of this material was added, with thorough mixing, 0.97 grams of cobalt naphthenate solution to provide 250 ppm of cobalt based on the weight of the nanoparticle-containing gel coat.

The resulting nanoparticle-containing gel coat was used to prepare samples for evaluation as follows. Into a wide-mouth plastic container having a lid was placed the resulting nanoparticle-containing gel coat and 1.0 wt. % (based on total weight of the nanoparticle-containing gel coat) of methylethylketone peroxide (MEKP) solution (ca. 35 wt. % solution) was added. The container was sealed and the contents mixed at 2000 revolutions/minute (rpm) for 30 seconds using a SpeedMixer™ dual asymmetric centrifuge (Model DAC 600 FVZ-sp, available from Flack Tek, Incorporated, Landrum, S.C.). After mixing the nanoparticle-containing gel coat was transferred to a float glass mold treated with VALSPAR MR 225 release material.

### Example 10

To a 1 liter round bottomed flask were added 152.5 grams of Gel Coat Base Resin 2 and 580 grams of Reactive, Surface-modified Nanoparticles 3E, and 0.60 grams of a 5% aqueous solution of PROSTAB 5198 inhibitor (200 ppm based on the total weight of Gel Coat Base Resin 2). The resulting dispersion was vacuumed stripped (Buchi rotary evaporator with a water aspirator) at a temperature of 50° C. for about 45 minutes to remove the majority of the solvent. When the dispersion became viscous it was removed from the evaporator and 100 grams of styrene was added and it was placed back on the evaporator. The resulting dispersion was vacuumed stripped at a temperature of 50° C. for about 15 minutes, evaluated by GC and found to contain 4.0% 1-methoxy-2-propanol and 17.0% styrene. Based on this information, 35 grams of styrene and 6 grams of water (to provide an azeotrope for further solvent removal) were added to the dispersion and it was placed back on the rotary evaporator. After 15 minutes the evaporated dispersion was viscous again and the above process repeated. The GC results indicated 1.1% 1-methoxy-2-propanol and 14.58% styrene. Another 20.7 grams of styrene was added to the dispersion. The resulting nanoparticle-containing gel coat had a viscous, white, translucent appearance. It was evaluated by TGA and found to have a “silica only” content of about 42 wt. %. To 252 grams of this material was added, with thorough mixing, 1.05 grams of cobalt naphthenate solution to provide 250 ppm of cobalt based on the weight of the nanoparticle-containing gel coat.

The resulting nanoparticle-containing gel coat was used to prepare samples for evaluation as follows. Into a wide-mouth plastic container having a lid was placed the resulting nanoparticle-containing gel coat and 1.0 wt. % (based on total weight of the nanoparticle-containing gel coat) of methylethylketone peroxide (MEKP) solution (ca. 35 wt. % solution) was added. The container was sealed and the contents mixed at 2000 revolutions/minute (rpm) for 30 seconds using a SpeedMixer™ dual asymmetric centrifuge (Model DAC 600 FVZ-sp, available from Flack Tek, Incorporated, Landrum, S.C.). After mixing the nanoparticle-containing gel coat was transferred to a float glass mold treated with VALSPAR MR 225 release material.

### Example 11

To a 1 liter round bottomed flask were added 157.7 grams of Gel Coat Base Resin 2 and 600 grams of Reactive, Surface-modified Nanoparticles 3F, and 0.60 grams of a 5% aqueous solution of PROSTAB 5198 inhibitor (200 ppm based on the total weight of Gel Coat Base Resin 2). The resulting dispersion was vacuumed stripped (Buchi rotary evaporator with a water aspirator) at a temperature of 50° C. for about 45 minutes to remove the majority of the solvent. When the dispersion became viscous it was removed from the evaporator, 100 grams of styrene was added and it was placed back on the rotary evaporator. After 15 minutes the evaporated dispersion was viscous again and it was removed from the evaporator. The GC results indicated 2.7% 1-methoxy-2-propanol and 13.24% styrene. Based on this information, 60 grams of styrene and 5 grams of water (to provide an azeotrope for further solvent removal) were added to the dispersion and it was placed back on the rotary evaporator. After 15 minutes the further evaporated dispersion was viscous again and the above process repeated. The GC results indicated 0% 1-methoxy-2-propanol and 11.8% styrene. Based on this information, 34.3 grams of styrene was added to the dispersion. The resulting nanoparticle-containing gel coat had a viscous, white, translucent appearance. It was evaluated by TGA and found to have a “silica only” content of about 42 wt. %. To 261 grams of this material was added, with thorough mixing, 1.09 grams of cobalt naphthenate solution to provide 250 ppm of cobalt based on the weight of the nanoparticle-containing gel coat.

The resulting nanoparticle-containing gel coat was used to prepare samples for evaluation as follows. Into a wide-mouth plastic container having a lid was placed the resulting nanoparticle-containing gel coat and 1.0 wt. % (based on total weight of the nanoparticle-containing gel coat) of methylethylketone peroxide (MEKP) solution (ca. 35 wt. % solution) was added. The container was sealed and the contents mixed at 2000 revolutions/minute (rpm) for 30 seconds using a SpeedMixer™ dual asymmetric centrifuge (Model DAC 600 FVZ-sp, available from Flack Tek, Incorporated, Landrum, S.C.). After mixing the nanoparticle-containing gel coat was transferred to a float glass mold treated with VALSPAR MR 225 release material.

### Example 12

To a 1 liter round bottomed flask were added 159.7 grams of Gel Coat Base Resin 2 and 600 grams of Reactive, Surface-modified Nanoparticles 3G, and 0.60 grams of a 5% aqueous solution of PROSTAB 5198 inhibitor (200 ppm based on the total weight of Gel Coat Base Resin 2). The resulting dispersion was vacuumed stripped (Buchi rotary evaporator with a water aspirator) at a temperature of 50° C. for about 45 minutes to remove the majority of the solvent. When the viscosity of the dispersion became relatively high it was removed from the evaporator and 100 grams of styrene was added and it was placed back on the rotary evaporator. After 15 minutes the viscosity was again relatively high and it was removed from the evaporator. The GC results indicated 6.6% 1-methoxy-2-propanol and 18.3% styrene. To the dispersion were added 40 grams of styrene and 10 grams of water (to provide an azeotrope for further solvent removal) and it was placed back on the rotary evaporator. After 15 minutes the viscosity was again relatively high and the above process repeated. The GC results indicated 2.3% 1-methoxy-2-propanol and 16.1% styrene. Accordingly, 50 grams of styrene and 5 grams of water were added to the dispersion and it was placed back on the rotary evaporator. After 15 minutes the viscosity was again relatively high and the above process repeated. The GC results indicated 0.9% 1-methoxy-2-propanol and 22.2% styrene. An additional 4.1 grams of styrene was added to the dispersion. The resulting nanoparticle-containing gel coat was viscous and had a white, translucent appearance. It was evaluated by TGA and found to have a “silica only” content of about 42 wt. %. To 265 grams of this material was added, with thorough mixing, 1.10 grams of a cobalt naphthenate solution to provide 250 ppm of cobalt based on the weight of the nanoparticle-containing gel coat.

The resulting nanoparticle-containing gel coat was used to prepare samples for evaluation as follows. Into a wide-mouth plastic container having a lid was placed the resulting nanoparticle-containing gel coat and 1.0 wt. % (based on total weight of the nanoparticle-containing gel coat) of methylethylketone peroxide (MEKP) solution (ca. 35 wt. % solution) was added. The container was sealed and the contents mixed at 2000 revolutions/minute (rpm) for 30 seconds using a SpeedMixer™ dual asymmetric centrifuge (Model DAC 600 FVZ, available from Flack Tek, Incorporated, Landrum, S.C.). After mixing the nanoparticle-containing gel coat was transferred to a float glass mold treated with VALSPAR MR 225 release material.

### Example 13

To a 1 liter round bottomed flask were added 153.7 grams of Gel Coat Base Resin 2 and 585 grams of Reactive, Surface-modified Nanoparticles 3H, and 0.60 grams of a 5% aqueous solution of PROSTAB 5198 inhibitor (200 ppm based on the total weight of Gel Coat Base Resin 2). The resulting dispersion was vacuum stripped (Buchi rotary evaporator with a water aspirator) at a temperature of 50° C. for about 45 minutes to remove the majority of the solvent. When the viscosity of the dispersion became relatively high it was removed from the evaporator, 100 grams of styrene was added and it was placed back on the rotary evaporator. After 15 minutes the viscosity was again relatively high and the above process repeated. The GC results indicated 8.0% 1-methoxy-2-propanol and 19.0% styrene. Based on this information, 50 grams of styrene was added to the dispersion and it was placed back on the rotary evaporator. After 15 minutes the viscosity was again relatively high and the above process repeated. The GC results indicated 3.3% 1-methoxy-2-propanol and 19.0% styrene. Based on this information, 30 grams of styrene and 5 grams of water were added to the dispersion and it was placed back on the rotary evaporator. After 15 minutes the viscosity was again relatively high and the above process repeated. The GC results indicated 1.1% 1-methoxy-2-propanol and 18.85% styrene. Based on this information, 14.36 grams of styrene was added to the dispersion. The resulting nanoparticle-containing gel coat was viscous and had a white, translucent appearance. It was evaluated by TGA and found to have a “silica only” content of about 40 to about 42 wt. %. To 265 grams of this material was added, with thorough mixing, 1.10 grams of a cobalt naphthenate solution to provide 250 ppm of cobalt based on the weight of the nanoparticle-containing gel coat.

The resulting nanoparticle-containing gel coat was used to prepare samples for evaluation as follows. Into a wide-mouth plastic container having a lid was placed the resulting nanoparticle-containing gel coat and 1.0 wt. % (based on total weight of the nanoparticle-containing gel coat) of methylethylketone peroxide (MEKP) solution (ca. 35 wt. % solution) was added. The container was sealed and the contents mixed at 2000 revolutions/minute (rpm) for 30 seconds using a SpeedMixer™ dual asymmetric centrifuge (Model DAC 600 FVZ-sp, available from Flack Tek, Incorporated, Landrum, S.C.). After mixing, the nanoparticle-containing gel coat was transferred to a float glass mold treated with Valspar MR 225 release material.

### Comparative Example 3

To 122 grams of Gel Coat Base Resin 2 was added, with thorough mixing, 0.29 grams of a cobalt naphthenate solution to provide 148 ppm of cobalt based on the weight of the gel coat. Next, into a wide-mouth plastic container having a lid was placed the cobalt-containing Gel Coat Base Resin 2 and 1.0 wt. % (based on total weight of Gel Coat Base Resin 2) of methylethylketone peroxide (MEKP) solution (ca. 35 wt. % solution) was added. The container was sealed and the contents mixed at 2000 revolutions/minute (rpm) for 30 seconds using a SpeedMixer™ dual asymmetric centrifuge (Model DAC 600 FVZ, available from Flack Tek, Incorporated, Landrum, S.C.). After mixing the contents were transferred to a float glass mold treated with VALSPAR MR 225 release material.

TABLE 3
Summary description of the reactive, surface-modified nanoparticles.

| | | Particle | |
|---|---|---|---|
| Ex. | Particles | Size (nm) | Silane Treatment |
| 7 | 3D | 107 | A174:A1230/1:1 |
| 8 | 2C | 77 | A174:A1230/1:1 |
| 9 | 1B | 22 | A174:A1230/1:1 |
| 10 | 3E | 107 | CLM Silane |
| 11 | 3F | 107 | CLM Silane:A1230/1:1 |
| 12 | 3G | 107 | Styryl Silane:A1230/1:1 |
| 13 | 3H | 107 | CLM Silane |
| CE 3 | none | none | none |

The cured samples of Examples 7-13 and Comparative Example 3 were evaluated for fracture toughness, dynamic flexural modulus, glass transition temperature, and Barcol hardness. The results are presented in Table 4 below.

For fracture toughness testing and Barcol hardness testing, the samples were allowed to cure at room temperature overnight at room temperature followed by post-curing in an oven for 1 hour at 125° C., then removed and allowed to cool to room temperature. The nominal inside dimensions of the mold were 8.9 cm high by 18 cm wide by 0.63 cm thick (3.5 inches high by 7 inches wide by 0.25 inches thick).

Flexural storage modulus, E′, was measured using an RSA2 Solids Analyzer (available from Rheometrics Scientific Inc., Piscataway, N.J.) in a dual cantilever beam mode. The specimen dimensions had nominal measurements of 50 millimeters long by 6 millimeters wide by 1.5 millimeters thick. A span of 40 millimeters was employed. Two scans were run, the first having a temperature profile of −25° C. to +125° C. and the second −25° C. to +150° C. Both scans employed a temperature ramp of at 5° C./minute, a frequency of 1 Hertz and a strain of 0.1%. The sample was cooled after the first scan using a refrigerant at an approximate rate of 20° C./minute after which the second scan was immediately run. The flexural modulus, E′, at +25° C. and the tan delta peak (Tg) on the second scan were reported.

Barcol Hardness measurements were made on the samples that had been evaluated for flexural modulus after that testing was completed.

TABLE 4
Properties of Examples 7-13 and Comparative Example 3.

| | Tg | E′ | Barcol | Fracture Toughness (MPa(m^{1/2})) | | | | | |
|---|---|---|---|---|---|---|---|---|---|
| Ex. | (° C.) | (GPa) | Hardness | K_{q} | S.D. | n | K_{1C} | S.D. | n |
| 7 | 116 | 6.53 | 62 | 0.77 | 0.07 | 10 | 0.75 | 0.03 | 1 |
| 8 | 114 | 4.93 | 60 | 0.82 | 0.06 | 5 | 0.78 | — | 1 |
| 9 | 107 | 4.08 | 49 | ND | — | — | ND | — | — |
| 10 | 113 | 6.45 | 64 | 0.73 | 0.07 | 9 | 0.72 | 0.05 | 5 |
| 11 | 117 | 5.80 | 61 | 0.79 | 0.04 | 9 | 0.81 | 0.02 | 9 |
| 12 | 115 | 5.57 | 62 | 0.76 | 0.04 | 7 | 0.77 | 0.05 | 4 |
| 13 | 115 | 5.84 | 60 | 0.79 | 0.04 | 9 | 0.75 | — | 1 |
| CE 3 | 130 | 3.34 | 46 | 0.52 | 0.06 | 10 | 0.58 | 0.04 | 2 |

ND = not determined.

### Example 14

Using a Silverson L4R mixer (available from Silverson Machines, Limited, Chesham, England), 333.3 grams of the Surface Modified Nanoparticles 4A were high shear mixed into 777 grams acetone for 15 minutes. After the high shear mixing was complete, 297.2 grams 3M Gel Coat Base Resin 3 and 3.5 grams PROSTAB 5198 (5% in water) were then added and the acetone was removed with rotary evaporation. 120 grams TiO₂ was slowly high shear mixed into 280 grams styrene and 4.8 grams Disperbyk 111. The TiO₂ dispersion was then combined with the above SiO₂ dispersion and the excess styrene was removed by rotary evaporation. Evaluation of the evaporated dispersion by GC confirmed there was no acetone present and the styrene concentration was 12.8 wt. %. Forty grams of styrene and 1.44 grams of cobalt napthenate were added to about 740 grams of the evaporated dispersion. Thermogravimetric analysis of the final sample indicated 53.83 wt. % inorganic residue. Measurements were taken on samples that were cured at room temperature for 24 hours and then postcured at 70° C. for 4 hours.

### Example 15

Using a Silverson L4R mixer (available from Silverson Machines, Limited), 336.8 grams Surface Modified Nanoparticles 4B were high shear mixed into 785 grams acetone for 15 minutes. To this, 397.0 grams 3M Gel Coat Base Resin 3 and 4.6 grams PROSTAB 5198 (5% in water) were then added and the acetone was removed with rotary evaporation. When the sample became viscous and white, 90 grams of styrene were added and the flask was put back on the rotary evaporator to continue acetone removal. Evaluation of the evaporated sample by GC confirmed there was no acetone present and the styrene concentration was 25 wt. %. About 740 grams of the evaporated sample was then combined with 16.8 grams styrene, 205.9 grams 3M Gel Coat Base Resin 3 and 2.79 grams cobalt napthenate. Thermogravimetric analysis of the final sample confirmed 31.19 wt. % inorganic residue. Measurements were taken on samples that were cured at room temperature for 24 hours and then postcured at 70° C. for 4 hours.

### Comparative Example 4

Using a Silverson L4R mixer (available from Silverson Machines, Limited), 347.8 grams Surface Modified Nanoparticles 4C were high shear mixed into 811 grams acetone for 15 minutes. To this, 387.6 grams 3M Gel Coat Base Resin 3 and 4.5 grams PROSTAB 5198 (5% in water) were added and the acetone was removed with rotary evaporation. When the sample became viscous, 70 grams of styrene were added and then put back on the rotary evaporator to continue acetone removal. When the sample became viscous again, 40 grams styrene was added. When GC analysis confirmed that no acetone remained, the sample was finished. According to GC analysis of the finished sample, the styrene concentration was 11.5 wt. %. To about 690 grams of the finished sample, 99.0 grams styrene and 1.9 grams cobalt napthenate were added. Thermogravimetric analysis of the final sample confirmed 40.37% inorganic residue. Measurements were taken on samples that were cured at room temperature for 24 hours and then postcured at 70° C. for 4 hours.

### Example 16

Using a Silverson L4R mixer (available from Silverson Machines, Limited) 344.1 grams Surface Modified Nanoparticles 4D were high shear mixed into 800 grams acetone for 15 minutes. To this, 390.8 grams 3M Gel Coat Base Resin 3 and 4.5 grams PROSTAB 5198 (5% in water) were then added and the acetone was removed with rotary evaporation. When the sample became viscous and white, 80 grams styrene was added and the sample was put back on the rotary evaporator to continue acetone removal. When GC analysis of the sample confirmed that no acetone remained, the sample was finished. According to GC analysis of the finished sample, the styrene concentration was 16.8 wt. %. To about 56.6 grams styrene and 1.8 grams cobalt napthenate were added to 728 grams of the finished sample. Thermogravimetric analysis of the final sample confirmed 40.65 wt. % inorganic residue. Measurements were taken on samples that were cured at room temperature for 24 hours and then postcured at 70° C. for 4 hours.

### Example 17

Using a Silverson L4R mixer (available from Silverson Machines, Limited), 333.8 grams Surface Modified Nanoparticles 4E was high shear mixed into 773 grams acetone for 15 minutes. To this, 399.6 grams 3M Gel Coat Base Resin 3 and 4 grams of a 5% PROSTAB 5198 solution were added and the acetone was removed with rotary evaporation. When the sample became viscous and white, 100 grams styrene was added and then put back on the rotary evaporator to continue removing acetone. According to GC analysis of the finished samples, there was no acetone present and the styrene concentration was 23 wt. %. 342 g sample, 73.3 g 3M Gel Coat Base Resin 3, 12.2 g styrene and 1.25 grams cobalt napthenate were speed mixed together. Thermogravimetric analysis confirmed 32.38 wt. % inorganic residue. Measurements were taken on samples that were cured at room temperature for 24 hours and then postcured at 70° C. for 4 hours.

### Example 18

Using a Silverson L4R mixer (available from Silverson Machines, Limited), 340.8 grams Surface Modified Nanoparticles 4A were high shear mixed into 795 grams acetone for 15 minutes. To this, 393.6 grams 3M Gel Coat Base Resin 3 and 4 grams 5% PROSTAB 5198 solution were added and the acetone was removed with rotary evaporation. When the sample became viscous and white, 100 grams styrene was added and then put back on the rotary evaporator to continue removing acetone. According to GC analysis, there was no acetone in the evaporated sample and the styrene concentration was 19 wt. %. To about 745 grams of the evaporated sample, 35 grams of styrene and 1.95 grams cobalt napthenate were added. Thermogravimetric analysis confirmed 39.60 wt. % SiO2. Measurements were taken on samples that were cured at room temperature for 24 hours and then postcured at 70° C. for 4 hours.

### Example 19

Using a Silverson L4R mixer (available from Silverson Machines, Limited), 250.0 grams Surface Modified Nanoparticles 4A were high shear mixed into 580 grams acetone for 15 minutes. To this, 471.4 grams 3M Gel Coat Base Resin 3 and 5.5 grams 5% PROSTAB 5198 solution were added and the acetone was removed with rotary evaporation. When the sample became viscous and white, 100 grams styrene was added and then put back on the rotary evaporator to continue removing acetone. According to GC analysis, there was no acetone in the evaporated sample and the styrene concentration was 22.8 wt. %. To about 740 grams of the evaporated sample, 48 grams styrene and 2.3 grams of cobalt napthenate were added. Thermogravimetric analysis confirmed 29.42 wt. % SiO2. Measurements were taken on samples that were cured at room temperature for 24 hours and then postcured at 70° C. for 4 hours.

### Comparative Example 5

About 80 grams styrene, 3.33 grams cobalt napthenate, and 720 grams 3M Gel Coat Base Resin 3 were mixed together. The resulting nanoparticle-containing gel coats were used to prepare samples for evaluation as follows. Into a wide-mouth plastic container having a lid was placed the resulting nanoparticle-containing gel coat and 1.0 wt. % (based on total weight of styrene and the 3M Gel Coat Base Resin 3) of methylethylketone peroxide (MEKP) solution (ca. 35 wt. % solution) were added. The container was sealed and the contents mixed at 2000 revolutions/minute (rpm) for 30 seconds using a SpeedMixer™ dual asymmetric centrifuge (Model DAC 600 FVZ, available from Flack Tek, Incorporated, Landrum, S.C.). After mixing, the nanoparticle-containing gel coat was transferred to a float glass mold treated with Valspar MR 225 release material.

The cured samples of Examples 14-19 and Comparative Examples 4 and 5 were evaluated for fracture toughness, dynamic flexural modulus, glass transition temperature, neat resin tensile and Barcol hardness. The results are presented in Table 5 and 6 below.

For fracture toughness testing and hardness testing, the samples were allowed to cure at room temperature for 24 hours followed by post-curing in an oven for 4 hours at 70° C. After the molds and resins had cooled to room temperature, the resins were removed from the mold. The nominal inside dimensions of the mold were 8.9 cm high by 18 cm wide by 0.63 cm thick (3.5 inches high by 7 inches wide by 0.25 inches thick). The samples were saved and later used for Barcol Hardness measurements.

Fracture toughness of cured gel coat resins was measured according to ASTM D 5045-99 using a compact tension geometry wherein the specimens had nominal dimensions of 3.18 cm by 3.05 cm by 0.64 cm (1.25 in. by 1.20 in. by 0.25 in.). The following parameters were employed: W=2.54 cm (1.00 in.); a=1.27 cm (0.50 in.); B=0.64 cm (0.25 in.). In addition, a modified loading rate of 0.13 cm/minute (0.050 inches/minute) was used. Measurements were made on between 6 and 10 specimens for each gel coat resin tested. Average values for both Kq and KIC were reported in units of MegaPascals times the square root of meters, i.e., MPa(m½), along with the number of samples used and standard deviation. Only those specimens meeting the validity requirements were used in the calculations.

For flexural modulus and glass transition temperature, the samples were cured at room temperature for 24 hours followed by post-curing in an oven for 4 hours at 70° C. After the molds and resins had cooled to room temperature, the resins were removed from the mold. The nominal inside dimensions of the mold were 2.5 cm high by 5 cm wide by 0.16 cm thick (1 inch high by 2 inches wide by 0.062 inches thick).

Flexural storage modulus, E′, of cured gel coat resins was measured using an RSA2 Solids Analyzer (available from Rheometrics Scientific Inc., Piscataway, N.J.) in a dual cantilever beam mode. The specimen dimensions had nominal measurements of 50 millimeters long by 6 millimeters wide by 1.5 millimeters thick. A span of 40 millimeters was employed. Two scans were run, both having a temperature profile of −25° C. to +150° C. Both scans employed a temperature ramp of at 5° C./minute, a frequency of 1 Hertz and a strain of 0.1%. The sample was cooled after the first scan using a refrigerant at an approximate rate of 20° C./minute after which the second scan was immediately run. The flexural modulus, E′, at +25° C. on the first scan was reported. The tan delta peak of the first scan was reported as the glass transition temperature (Tg).

For neat resin tensile testing, the samples were cured at room temperature for 24 hours followed by post-curing in an oven for 4 hours at 70° C. After the molds and resins had cooled to room temperature, the resins were removed from the mold. The nominal inside dimensions of the mold were 9 cm high by 23 cm wide by 0.63 cm thick (3.5 inches high by 9 inches wide by 0.125 inches thick).

Neat resin tensile properties—modulus, failure stress, and failure strain—were were measured at room temperature in accordance with ASTM D638. An MTS/SinTech 5/GL test machine (SinTech, A Division of MTS Systems, Inc., P.O. Box 14226, Research Triangle Park, N.C. 27709-4226) was used, and an extensometer with a gage length of one inch. Specimen test sections were nominally 4″ long×¾″ wide×⅛″ thick and the loading rate was 0.20 in/min. The modulus was taken to be the stress-strain curve fit of between 1000 and 2000 psi (linear region). Three to five specimens were tested.

A Brookfield viscometer, Model DV-II+ (Brookfield Eng Labs, Inc. Stoughton, Mass. 02072), was used to measure resin viscosity at room temperature. A #4 spindle was used at 5 rpm and at 50 rpm. Readings were taken approximately 30 seconds after the motor was turned on. If use of the #4 spindle resulted in off-scale readings a value of “EEEE” was reported and other spindles were used. The Thixotropic Index (TI) was taken to be the ratio of the viscosity measured at 5 rpm divided by the viscosity measured at 50 rpm. Units are centipoise.

TABLE 5
Summary of examples descriptions

| | | | | | Wt % |
|---|---|---|---|---|---|
| | | Wt % | Nano- | | Titanium |
| | Parti- | Nano- | particle | Silane Treatment | Dioxide |
| Ex. | cles | particles | Size (nm) | (molar ratios) | Pigment |
| 14 | 4A | Approx 40 | 75 | A174:A1230/(1:1) | Approx 15 |
| 15 | 4B | 31.19 | 75 | A174:A1230/(1.5:1) | 0 |
| 16 | 4D | 40.65 | 75 | CLM Silane | 0 |
| 17 | 4E | 32.38 | 75 | A174 | 0 |
| 18 | 4A | 39.60 | 75 | A174:A1230/(1:1) | 0 |
| 19 | 4A | 29.42 | 75 | A174:A1230/(1:1) | 0 |
| CE 4 | 4C | 40.37 | 75 | A1230 | 0 |
| CE 5 | none | none | none | none | 0 |

TABLE 6
Summary of Mechanical Properties

| | | | Barcol | K_{IC} |
|---|---|---|---|---|
| Ex. | Tg (° C.) | E′ (GPa) | Hardness | (MPa(m)\hat{ }1/2) |
| 14 | 98 | 5.6 | 58 | 1.05 |
| 15 | 99 | 6.5 | 58 | 0.86 |
| 16 | 98 | 4.9 | 62 | 0.93 |
| 17 | 98 | 5.4 | 59 | 1.00 |
| 18 | 98 | 4.3 | 60 | 0.89 |
| 19 | 95 | 3.6 | 56 | 0.94 |
| CE 4 | 94 | 4.7 | 49 | 0.83 |
| CE 5 | 101 | 3.9 | 43 | 0.66 |

TABLE 7
Summary of Neat Resin Tensile Properties

| | | Failure | Failure |
|---|---|---|---|
| Example | Modulus | Stress | Strain |
| number | Mean KSI | Mean psi | Mean % |
| 14 | 910 | 9030 | 1.5 |
| 15 | 690 | 9820 | 1.8 |
| 16 | 860 | 7220 | 1.0 |
| 17 | 730 | 5280 | 0.8 |
| 18 | 680 | 10020 | 2.8 |
| 19 | 621 | 10080 | 2.8 |
| CE 4 | 522 | 7160 | 2.2 |
| CE 5 | 480 | 11440 | 4.1 |

TABLE 8
Brookfield Viscometer measurements

| | RV SPINDLE 4 | | | RV SPINDLE 5 | | | RV SPINDLE 6 | | | RV SPINDLE 7 | | |
|---|---|---|---|---|---|---|---|---|---|---|---|---|
| | 30 sec | | | 30 sec | | | 30 sec | | | 30 sec | | |
| | | | TI (5 rpm/ | | | TI (5 rpm/ | | | TI (5 rpm/ | | | TI (5 rpm/ |
| Ex | 5 rpm | 50 rpm | 50 rpm) | 5 rpm | 50 rpm | 50 rpm) | 5 rpm | 50 rpm | 50 rpm) | 5 rpm | 50 rpm | 50 rpm) |
| 17 | EEEE | EEEE | na | 72640 | EEEE | na | 76400 | 14850 | 5.1 | | | |
| 18 | 3560 | 2454 | 1.5 | 3760 | 2544 | 1.5 | | | | | | |
| 19 | 3360 | 2344 | 1.4 | 3280 | 2352 | 1.4 | | | | | | |
| 14 | 20480 | 3164 | 6.5 | 18800 | EEEE | na | | | | | | |
| 15 | 31560 | 3140 | 10.1 | 70880 | 6312 | 11.2 | | | | | | |
| CE4 | 4600 | 2850 | 1.6 | 4560 | 2848 | 1.6 | | | | | | |
| 16 | 31600 | 3140 | 10.1 | EEEE | EEEE | na | 126600 | EEEE | na | 156000 | 34880 | 4.5 |
| CE5 | 500 | 496 | 1.0 | 480 | 488 | 0.98 | | | | | | |

Various modifications and alterations of this invention will become apparent to those skilled in the art without departing from the scope and spirit of this invention.

What is claimed is:

1. A composition comprising a resin system, wherein the resin system comprises
a crosslinkable resin;
a reactive diluent; and
a plurality of reactive, surface-modified nanoparticles, wherein the surface-modified nanoparticles comprise a core having a surface and a first surface treatment agent, wherein the first surface treatment agent comprises a first functional group attached to the surface of the core and a second functional group capable of reacting with at least one of the crosslinkable resin and the reactive diluent.

2. The composition of claim 1, wherein the composition is substantially free of reactive rubber domains.

3. The composition of claim 1, wherein the resin system comprises 5 to 60 percent by weight of the reactive, surface-modified nanoparticles.

4. The composition of claim 1, wherein the resin system comprises less than or equal to 40 percent by weight reactive diluent.

5. The composition claim 1, wherein the crosslinkable resin comprises an unsaturated polyester resin.

6. The composition of claim 1, wherein the crosslinkable resin comprises a reaction product of one or more epoxy resins with one or more ethylenically-unsaturated monocarboxylic acids.

7. The composition of claim 1, wherein the reactive diluent is an ethylenically unsaturated monomeric compound.

8. The composition of claim 1, wherein the surface of the core comprises an inorganic oxide.

9. The composition of claim 1, wherein at least a portion of the reactive, surface modified nanoparticles further comprise a second surface treatment agent, wherein the second surface treatment agent is attached to the surface of the core.

10. The composition of claim 1, wherein the first functional group covalently attaches the first surface treatment agent to the core.

11. The composition of claim 1, wherein the cores of the reactive, surface-modified nanoparticles comprise silica and the first surface treatment agent comprises a silane.

12. The composition of claim 1, wherein the surface-modified nanoparticles have an average particle size of from 5 nanometers to 250 nanometers.

13. The composition of claim 1 further comprising an additive selected from the group consisting of a curing agent, an initiator, an activator, a catalyst, a crosslinking agent, an inhibitor, a dye, a pigment, a flame retardant, an impact modifier, a promoter, an air release agent, a wetting agent, a leveling agent, a surfactant, a suppressant, and a flow control agent, wherein the composition is a gel coat.

14. The composition of claim 1 further comprising a thixotropic agent, wherein the composition has a thixotropic index greater than or equal to 4.

15. The composition of claim 1, wherein the weight percent of the first surface treatment agent, based on a total weight of the composition, is selected such that the composition has a thixotropic index greater than or equal to 4.

16. The composition of claim 1, wherein approximately a monolayer of surface treatment agents is attached to the surface of the reactive, surface-modified nanoparticles.

17. An article comprising a substrate and a cured gel coat layer attached to a surface of the substrate, wherein the cured gel coat layer comprises a reaction product of
a crosslinkable resin;
a reactive diluent; and
a plurality of reactive, surface-modified nanoparticles, wherein the surface-modified nanoparticles comprise a core having a surface and a first surface treatment agent, wherein the first surface treatment agent comprises a first functional group attached to the surface of the core and a second functional group reacted with at least one of the crosslinkable resin and the reactive diluent.

18. The article of claim 17, wherein the article is selected from the group consisting of a vehicle and a fixture.

19. The article of claim 17, wherein the substrate comprises a fibrous reinforced composite.
